(19) United States
(12) Patent Application Publication
(10) Pub. No.: US 2025/0284065 A1
(43) Pub. Date: Sep. 11, 2025

(54) OPTICAL SWITCH UTILIZING OPTICAL BEAM STEERING

(71) Applicant: Huber+Suhner Polatis Limited, Cambridge (GB)

(72) Inventors: David James Montgomery, Cambridge (GB); Peter John Wilkinson, Cambridge (GB)

(21) Appl. No.: 18/861,290

(22) PCT Filed: Apr. 28, 2023
(86) PCT No.: PCT/GB2023/051136

§ 371 Date: Oct. 29, 2024

(30) Foreign Application Priority Data
Apr. 29, 2022 (GB) 2206310.1
Dec. 21, 2022 (GB) 2219348.6

(51) Int. Cl. G02B 6/35

(52) U.S. Cl. CPC G02B 6/3546

(57) ABSTRACT

An optical switch comprising a set of input ports and a set of output ports, each input and output port configured to transport an optical signal having at least one component frequency channel. The switch comprises a first programmable deflection plane configured to deflect beams incident on it from the set of input ports to form a deflected array of beams, and a second programmable deflection plane configured to deflect beams incident on it towards the set of output ports. The switch also comprises a beam steering optical device positioned in the optical path between the first and second programmable deflection planes, configured to remap the deflected array of beams to form a remapped array of beams directed to the second programmable deflection plane, by changing the spatial positioning and/or orientation of each beam from the deflected array of beams in the remapped array of beams such that the spatial positioning and/or orientation of at least one beam of the deflected array of beams is changed differently to at least one other beam of the deflected array of beams.

### BACKGROUND

Optical switches are used in optical telecommunication systems to route optical signals through networks. As optical telecommunications systems have become more popular, the quantity of data carried through the networks has increased, putting greater capacity demands on the switches. It is known to use wavelength division multiplexed (WDM) signals to enable each optical fibre in the network to carry multiple data channels, those data channels separated by unique central frequencies and having non-overlapping bandwidths. Wavelength selective switches (WSSs) are used to route WDM signals through the network.

FIG. 1 illustrates schematically a known M×N WSS 100. The M×N switch comprises N input ports 101 and M output ports 102. Each port carries multiple data channels. A bank of 1×M WSSs 103 splits the multiplexed signal from each input port into its separate frequency channels. The demultiplexed data channels are then directed to the M output ports. A bank of N×1 WSSs 104 at the output combines the data channels into a set of multiplexed signals for output via the output ports 102. In this way, the M×N switch is able to redirect any data channel from an input port to any data channel in an output port, subject to the condition that two channels with overlapping frequencies are not routed to the same output port.

FIG. 2 illustrates schematically a known switch referred to as an add-drop WSS 200. Add-drop WSS 200 is a special type of WSS in which N input ports 201 are connected to K output ports 202, where K>N. A bank of 1×K WSSs 203 splits the multiplexed signal from each input port into its separate frequency channels. The demultiplexed data channels are then directed to K space switches 204. Each space switch 204 can accept data from any of the 1×K WSSs but can only output data from one of the input ports at a time. The output of each space switch 204 is then output from an output port 202, otherwise known as a drop port. Space switches are simpler to implement than N×1 switches, and hence the add-drop WSS of FIG. 2 is preferable to the M×N WSS of FIG. 1. This is particularly the case when K is much bigger than N, and the data density in the K output ports is much lower than in the N input ports.

Both the WSSs of FIGS. 1 and 2 are reversible. For example, edge reconfigurable optical add-drop multiplexers (ROADM) are used for transferring optical data between core dense wavelength divisional multiplexing (DWDM) and more coarse wavelength division multiplexing (CWDM). An add-drop WSS of the type in FIG. 2 is used in the “dropping” direction shown in FIG. 2 to transfer from DWDM to CWDM, and in the reverse “adding” direction (from K drop input ports to N output ports) to transfer from CWDM to DWDM.

The switches shown in FIGS. 1 and 2 are typically implemented by electronic conversion, for example by absorbing light and emitting it again in the desired format. However, electronic conversion has high power requirements and introduces a significant lag in the transmission through the switch. Purely optical methods are preferred because they require much less power than electronic implementations and also enable faster transmission.

FIG. 3 illustrates a known optical implementation 300 of the M×N WSS of FIG. 1 or the add-drop WSS of FIG. 2. N input ports 301 each carry multiple channels. Light through each input port 301 is directed to an imaging telescope 302 where it is focused to a point, and then imaged by a 4F optical system 303. This produces parallel light beams which are then split into their constituent frequency channels by diffraction grating 304. The dispersed channels are focussed through lens 305 to a spatial light modulator (SLM) plane 306, which is typically implemented by a liquid crystal on silicon (LCOS) device. The LCOS device applies a holographic beam deflection to the spectrum of channels incident on it to direct each channel from the N input spectra towards the M spectra on a second SLM plane 308. The deflected channels pass through a Fourier lens (or lens group) 307 to form the conjugate plane before reaching the second SLM plane 308. The second SLM plane 308 is typically an LCoS or optical microelectromechanical system (MEMS). The second SLM plane 308 applies an angle deflection to the light incident on it to direct it towards the output ports 309. The M deflected spectra pass through a lens 310 to generate parallel light beams, which then travel through diffraction grating 311 to recombine the spectra for each of the M output ports 309. The recombined spectra then pass through 4F optical system 312. Fourier lens arrangement 314 is used to select the port which the multiplexed signals are then output through.

An undeviated beam 315 is aligned with the central output port 309a. An angular deflection to this beam channel 316 of a certain magnitude selects an alternative output port 309b. The deflection of the second SLM plane 308 corrects for the incidence angle from the different spectra on the first SLM plane 306 so that light from any of the input port spectra can be coupled to any of the output ports.

For the M×N WSS implementation, the second SLM plane 308 of FIG. 3 is a pixelated SLM such as an LCoS. For the add-drop WSS implantation, the second SLM plane 308 of FIG. 3 can be a MEMS array that is pixelated in one direction only (vertical) in order to act as the space switches. In this case, the second SLM plane 308 may be before or after the second diffraction grating 311.

These known optical WSSs utilise two separate SLM devices, one for each of the SLM planes 306, 308. SLM devices are expensive and limit the compactness of the WSS. Even with the simpler add-drop WSS, the switching is between a vertical column of input spectra on the first SLM plane 306 to a vertical column of space switch areas on the second SLM plane 308. The large deflection angle on the two SLM planes required to switch light from the top spectra on the first SLM plane 306 to the bottom space switch on the second SLM plane 308 limits the number of accessible output ports M that can be obtained with this arrangement, and hence limits the capacity of a switch having this type of architecture.

Utilising a single SLM device plane for both SLM planes of an add-drop WSS has been contemplated, for example by U.S. Pat. No. 11,079,551. The single SLM device plane has an area for spectra corresponding to SLM plane 306 of FIG. 3 and an area for space switches corresponding to SLM plane 308 of FIG. 3. FIG. 4 illustrates a single SLM device plane 400 of this type, having a column of space switches 401 and a column of spectra 402. It can easily be seen that the SLM area is not optimally used. Whilst a large portion of the SLM area is unused, the height of the SLM area limits the number of space switches 401 and the height of the spectra 402. This in turn limits the number of switchable positions and hence capacity of the system, and also the diffraction efficiency of the system.

US 2016/0234574 describes utilising a single SLM device for both SLM planes of an add-drop WSS involving switching between a vertical input spectra on the first SLM plane and a horizontal space switch distribution on the second SLM plane. However, the optical implementation of how to achieve this is not disclosed.

There is a need for a more compact WSS with increased capacity achieved by better utilisation of the available area of its constituent SLM planes so as to maximise the number of ports which can be used.

### SUMMARY OF THE INVENTION

According to an aspect of the invention, there is provided an optical switch comprising: a set of input ports, each input port configured to transport an optical signal having at least one component frequency channel; a set of output ports, each output port configured to transport an optical signal having at least one component frequency channel; a first programmable deflection plane configured to deflect beams incident on it from the set of input ports to form a deflected array of beams; a second programmable deflection plane configured to deflect beams incident on it towards the set of output ports; and a beam steering optical device positioned in the optical path between the first and second programmable deflection planes, the beam steering optical device configured to remap the deflected array of beams from the first programmable deflection plane to form a remapped array of beams directed to the second programmable deflection plane, by changing the spatial positioning and/or orientation of each beam from the deflected array of beams in the remapped array of beams such that the spatial positioning and/or orientation of at least one beam of the deflected array of beams is changed differently to at least one other beam of the deflected array of beams.

The beam steering optical device may be configured to remap the deflected array of beams by causing them to undergo two individual reflections, refractions or diffractions.

The beam steering optical device may be configured to remap the deflected array of beams by transposing them in two orthogonal directions.

The deflected array of beams may have a linear distribution, and the remapped array of beams may have a non-linear distribution.

The deflected array of beams may be a single column array, and the remapped array of beams may be a two-dimensional array.

The deflected array of beams may be a two-dimensional array, and the remapped array of beams may be a single column array.

The deflected array of beams may be a two-dimensional array having a first configuration, and the remapped array of beams may be a two-dimensional array having a different configuration to the first configuration.

The beam steering optical device may comprise one or more of the following passive components: a prism, a mirror array, a catadioptric system, a freeform lens and mirror, a diffractive optical element, a diffractive optical element array, a holographic optical element and a holographic optical element array.

The beam steering optical device may comprise one or more of the following electrically switchable components: an optical microelectromechanical system (MEMS) array, and a liquid crystal on silicon (LCoS) device.

The beam steering optical device may comprise a single optical element only.

The beam steering optical device may comprise a first optical element, a second optical element and a conjugate Fourier lens, wherein the conjugate Fourier lens is positioned in the optical path between the first and second optical elements.

The beam steering optical device may comprise a prism comprising: a first retroreflecting structure configured to provide an optical path for a first set of beams of the deflected array of beams; and a second retroreflecting structure configured to provide an optical path for a second set of beams of the deflected array of beams through a periscope prism, so as to alter the conformal arrangement of the first and second sets of beams of the deflected array of beams thereby forming the remapped array of beams having a geometrical distribution which matches the geometrical distribution of the image of the set of output ports on the second programmable deflection plane.

The beam steering optical device may comprise a mirror array comprising: a first pair of mirrors configured to provide an optical path for a first set of beams of the deflected array of beams; and a second pair of mirrors configured to provide an optical path for a second set of beams of the deflected array of beams, the first and second pairs of mirrors having differently angled surfaces so as to alter the conformal arrangement of the first and second sets of beams of the deflected array of beams thereby forming the remapped array of beams having a geometrical distribution which matches the geometrical distribution of the image of the set of output ports on the second programmable deflection plane.

The beam steering optical device may comprise a prism comprising two orthogonal Amici Roof prisms configured to provide an optical path for the deflected array of beams so as to remap the deflected array of beams from a first configuration in a first direction to form the remapped array of beams having the first configuration in a direction orthogonal to the first direction.

The beam steering optical device may further comprise a retroreflecting mirror at the output of the orthogonal Amici Roof prisms.

The beam steering optical device may comprise three differently angled reflecting surfaces configured to provide an optical path for the deflected array of beams so as to remap the deflected array of beams from a first configuration in a first direction to form the remapped array of beams having the first configuration in a direction orthogonal to the first direction.

The beam steering optical device may further comprise: an entrance micro lens located in the optical path input to the beam steering optical device from the first programmable deflection plane; and/or an exit micro lens located in the optical path output from the beam steering optical device to the second programmable deflection plane.

The optical switch may comprise a single spatial light modulator (SLM) panel comprising both the first programmable deflection plane and the second programmable deflection plane.

The images of the beams on the first programmable deflection plane and the images of the remapped array of beams on the second programmable deflection plane may cover over 80% of the area of the SLM panel.

The optical switch may further comprise an anamorphic correction telescope configured to focus the output of each input port of the set of input ports to an anamorphic focus image at an anamorphic focus point; wherein the beam steering optical device comprises: a first structure positioned adjacent to and above the anamorphic focus point, and a second structure positioned adjacent to and below the anamorphic focus point.

The optical switch may further comprise a lens configured to focus the output of each input port of the set of input ports to an input circular focus image at an input circular focus point; wherein the beam steering optical device comprises: a first structure positioned adjacent to and above the input circular focus point, and a second structure positioned adjacent to and below the input circular focus point.

The optical switch may further comprise an optical dispersion device configured to spatially separate the component frequency channels of optical signals incident on it from the set of input ports to form a set of dispersed optical signal beams; wherein the first programmable deflection plane is a spectral plane positioned in the optical path of the set of dispersed optical signal beams such that the set of dispersed optical signal beams form an array of images on the first programmable deflection plane, the first programmable deflection plane configured to apply a programmable deflection to each beam individually to form the deflected array of beams.

The optical switch may further comprise a multiplexer in the optical path between the first programmable deflection plane and the beam steering optical device, the multiplexer configured to multiplex the deflected array of beams from the first programmable deflection plane.

The first programmable deflection plane may be a space switch plane configured to deflect beams of non-dispersed optical signals to form the deflected array of beams, the optical switch further comprising: an optical dispersion device positioned in the optical path between the beam steering optical device and the second programmable deflection plane, the optical dispersion device configured to spatially separate the component frequency channels of the remapped array of beams, wherein the second programmable deflection plane is a spectral plane configured to apply a programmable deflection to each spatially separated component frequency channel beam of the remapped array of beams to form a spatially separated output array of beams; and a multiplexer in the optical path between the second programmable deflection plane and the set of output ports, the multiplexer configured to multiplex the spatially separated output array of beams to form a multiplexed output array of beams.

The multiplexer may be the optical dispersion device.

Both the first programmable deflection plane and the second programmable deflection plane may be spectral planes configured to deflect each image of a dispersed optical signal individually.

The optical switch may further comprise an optical dispersion device positioned in the optical path between the set of input ports and the first programmable deflection plane, the optical dispersion device configured to spatially separate the component frequency channels of optical signals from the set of input ports to form a set of dispersed optical signal beams; wherein the set of dispersed optical signal beams form an array of images on the first programmable deflection plane, the first programmable deflection plane configured to apply a programmable deflection to each beam of the array of beams individually to form the deflected array of beams.

The second programmable deflection plane may be configured to apply a programmable deflection to each spatially separated component frequency channel beam of the remapped array of beams to form a spatially separated output array of beams; the optical switch further comprising a multiplexer in the optical path between the second programmable deflection plane and the set of output ports, the multiplexer configured to multiplex the spatially separated output array of beams to form a multiplexed output array of beams.

The first programmable deflection plane may be a space switch plane configured to deflect beams of non-dispersed optical signals incident on it to form the deflected array of beams and the second programmable deflection plane may be a space switch plane configured to deflect beams of non-dispersed optical signals incident on it towards the set output ports.

The optical path between the set of input ports and the set of output ports may not include any optical dispersion devices.

The first pair of mirrors may comprise a first mirror and a second mirror, the first and second mirrors being parallel to one another; and the second pair of mirrors may comprise a third mirror and a fourth mirror, the third and fourth mirrors being parallel to one another.

The first set of beams of the deflected array of beams may be incident on the first mirror in a first direction and leave the second mirror in the first direction; and the second set of beams of the deflected array of beams may be incident on the third mirror in a second direction and leave the fourth mirror in the second direction.

The length of the optical path within the mirror array for the first set of beams of the deflected array of beams may be equal to the length of the optical path within the mirror array for the second set of beams of the deflected array of beams.

The optical path for the first set of beams and the optical path of the second set of beams may further comprise an optical system located between the first pair of mirrors and between the second pair of mirrors.

The optical system may comprise a Fourier lens and/or a 4F optical system.

The optical switch may comprise a mirror optic positioned in the optical path between the set of input ports and the first programmable deflection plane and between the first programmable deflection plane and the beam steering optical device, wherein the mirror optic is configured to direct the deflected light from the first programmable deflection plane towards the beam steering device.

The optical switch may comprise a mirror optic positioned in the optical path between the beam steering optical device and the second programmable deflection plane and between the second programmable deflection plane and the set of output ports, wherein the mirror optic is configured to direct the remapped array of beams to the second programmable deflection plane.

The mirror optic may comprise a pair of mirrors separated by a gap.

The optical path between the set of input ports and the beam steering optical device may comprise an optical component configured to apply an astigmatism to the beams from the input ports and the optical path between the beam steering device and the set of output ports may comprise an optical component configured to remove the astigmatism from the beams.

A beam incident on the first mirror may be divided into a first portion aligned with a first plane and a second portion aligned with a second plane which is orthogonal to the first plane; and the beam steering optical device may be configured to focus the first portion on the first mirror and focus the second portion on the second mirror.

The first plane may be the steering plane and the second plane may be the dispersion plane.

### BRIEF DESCRIPTION OF THE FIGURES

The present invention will now be described by way of example with reference to the accompanying drawings. In the drawings:

FIG. 1 illustrates a known M×N WSS;

FIG. 2 illustrates a known add-drop WSS;

FIG. 3 illustrates a known implementation of an M×N or add-drop WSS;

FIG. 4 illustrates an example distribution of spectra and space switches on a single prior art LCoS device;

FIG. 5 illustrates an add-drop WSS;

FIGS. 6a and 6b illustrate the optical path of the add-drop WSS of FIG. 5;

FIG. 7 illustrates an M×N WSS;

FIGS. 8a and 8b illustrate the optical path of a further add-drop WSS;

FIG. 9 illustrates the add-drop WSS of FIGS. 8a and 8b;

FIGS. 10a and 10b illustrate the optical path of a further add-drop WSS;

FIGS. 11, 12 and 13 illustrate add-drop WSSs with redistributed input and output ports;

FIGS. 14a and 14b illustrate an example distribution of spectra and space switches on a single LCoS device;

FIG. 15 illustrates a prism array implementation of a beam steering optical device;

FIG. 16 illustrates a mirror array implementation of a beam steering optical device;

FIG. 17 illustrates a further prism array implementation of a beam steering optical device;

FIG. 18 illustrates a further mirror array implementation of a beam steering optical device;

FIGS. 19a19a and 19b illustrate the optical path of an add-drop WSS having groups of input ports separated by a gap;

FIG. 20 illustrates an example distribution of spectra and space switches on a single LCoS device of an add-drop WSS having the optical path of FIGS. 19a19a and 19b;

FIGS. 21a and 21b illustrate the optical path of a further add-drop WSS;

FIG. 22 illustrates an example distribution of spectra and space switches on a single LCoS device of an add-drop WSS having the optical path of FIGS. 21a and 21b;

FIG. 23 illustrates an add-drop WSS having the optical path of FIGS. 21a and 21b;

FIG. 24 illustrates an add-drop WSS having the optical path of FIGS. 21a and 21b;

FIG. 25 illustrates a mirror array implementation of the optical structure;

FIG. 26 illustrates a prism array implementation of the optical structure;

FIG. 27 illustrates a further add-drop WSS;

FIGS. 28a, 28b and 28c illustrate detailed views of two composite structures of the add-drop WSS of FIG. 27;

FIG. 29 illustrates a further add-drop WSS;

FIG. 30 illustrates the add-drop WSS of FIG. 29 being operated in reverse;

FIG. 31 illustrates a further add-drop WSS;

FIG. 32 illustrates a further example of an M×N WSS;

FIGS. 33a, 33b, 33c, 33d and 33e illustrate four types of split aperture mirror (SAM);

FIG. 34 illustrates an arrangement of multiple WSSs of the type seen in FIG. 32.

FIG. 35 illustrates a further mirror array implementation of a beam steering optical device;

FIGS. 36a, 36b and 36c illustrate further mirror array implementations of the beam steering optical device;

FIGS. 37a, 37b and 37c illustrate further mirror array implementations of the optical structure; and

FIG. 38 illustrates a further implementation of the optical structure.

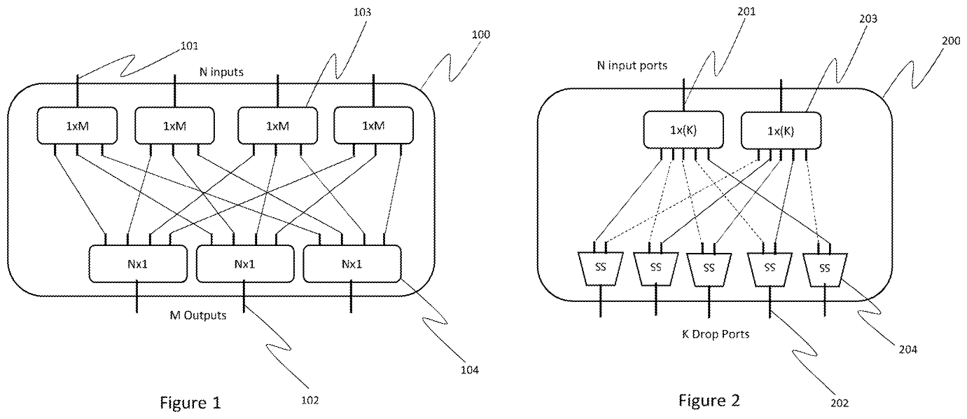

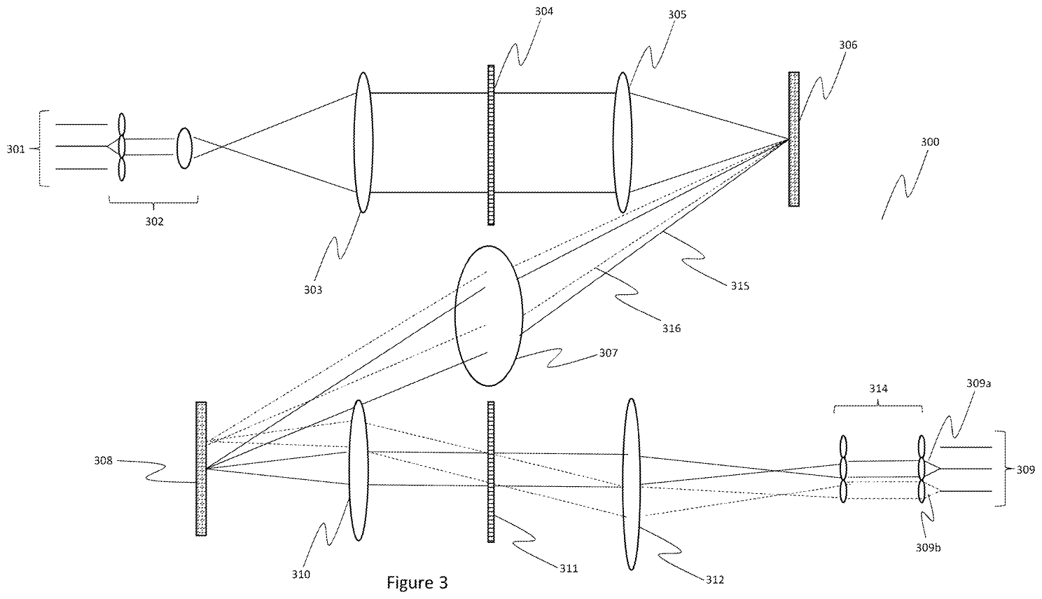

### DETAILED DESCRIPTION

The following describes several exemplary optical switches which utilise two programmable deflection planes and a beam steering optical device to optically route light from a set of input ports to a set of output ports. The described optical switches may be WSSs. These WSSs may be implemented as add-drop WSSs (adWSS), for example for transferring light from core DWDM networks to lower capacity CWDM networks. Alternatively, the described WSSs may be implemented as M×N WSSs. All the examples described herein use optical components to route the light through the switches. There is no absorption and re-emission of light.

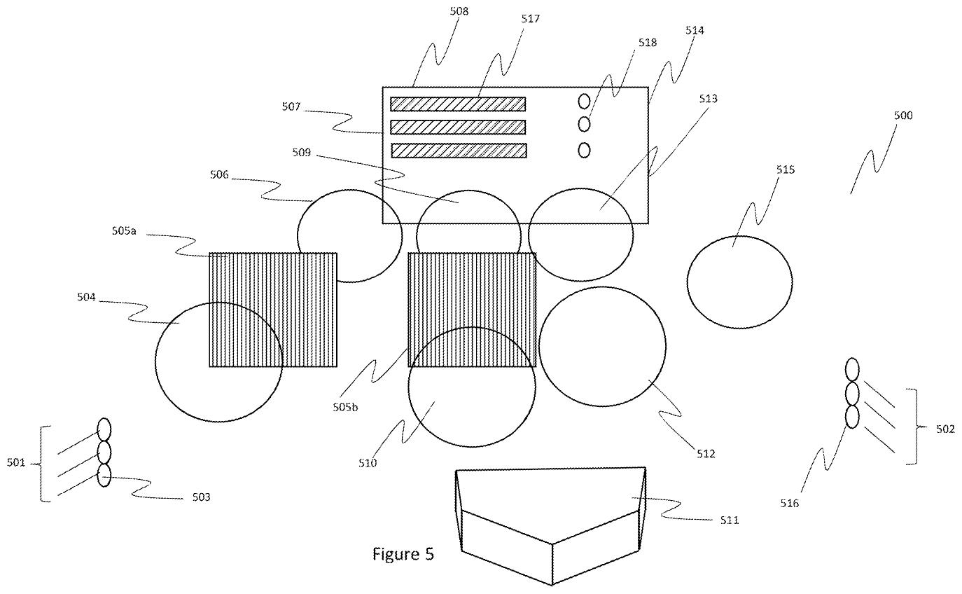

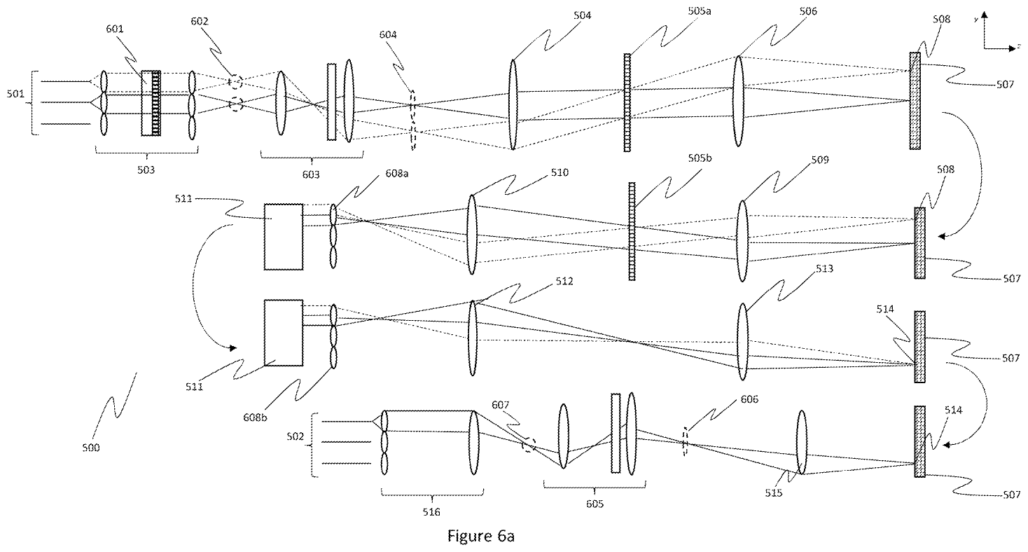

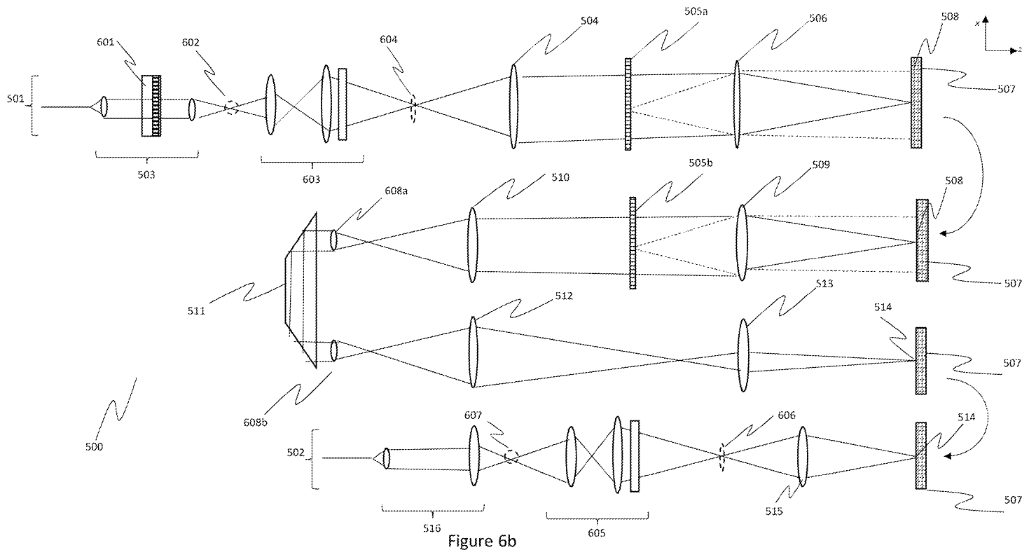

FIG. 5 illustrates an exemplary add-drop WSS 500 in which a single panel 507 comprises two programmable deflection planes 508, 514. This single panel may, for example, be an SLM device. FIGS. 6a and 6b illustrate the detailed optical path of the light as it is routed through the components of the switch. FIG. 6a illustrates the path in the switching plane, i.e. the y axis shown is the switching axis and the z axis is the optical axis. FIG. 6b illustrates the optical path in the dispersion plane, i.e. the x axis shown is the dispersion axis and the z axis is the optical axis. Thus, FIG. 6b illustrates an orthogonal plane to FIG. 6a.

In the adWSS of FIG. 5, light from a set of N ports 501 is routed to a set of K drop ports 502. Each port may comprise one or more optical fibres. Each port transports an optical signal having at least one component data channel. Typically, each port has a plurality of data channels. Each channel transports data. Each channel has a frequency band which has a different centre frequency to the other channels of that port. The channels of a port may have the same or different bandwidths. The bandwidths of the channels of a port are non-overlapping. As will be described below, each channel from each input port 501 may be routed to any individual output port 502.

The optical signals from the input ports 501 pass through coupling lenses 503 which form an optical beam of the N ports before a 4F imaging system. There is a coupling lens for each input port. The 4F imaging system comprises two lenses 504 and 506 separated by a diffraction grating 505a at the Fourier plane of lens 504. The diffraction grating 505a spatially separates the component frequency channels of the optical signal beams incident on it to form a set of dispersed optical signal beams. In other words, each optical signal from an input port is spread into its frequency spectrum by the diffraction grating 505a. Thus, the diffraction grating 505a acts to demultiplex each optical signal into its component data channels.

A first programmable deflection plane 508 is positioned in the optical path of the set of dispersed optical signals such that the set of dispersed optical signal beams form spectra 517 on the first programmable deflection plane 508. In the example of FIG. 5, three input ports 501 are illustrated, each of which forms a spectrum 518 on the first programmable deflection plane 508. Each spectrum forms an array of beams of the component data channels of the input port which are imaged on the first programmable deflection plane 508, each beam being a data channel. The first programmable deflection plane 508 applies a programmable deflection to each beam of the array of beams individually to form a deflected array of beams.

The degree of deflection applied to each beam is so as to change the angle of that beam to direct its data channel on a path towards a selected one of the output ports 502. The deflection applied by the first programmable deflection plane 508 is reconfigurable. Thus, a controller providing a control signal to the first programmable deflection plane 508 may change the deflection applied by the first programmable deflection plane 508 to each individual beam of the spectra from each input port, so as to output the desired channels to the desired ports.

The deflected array of beams from the first programmable deflection plane 508 then travels through a lens 509 and diffraction grating 505b in the Fourier plane of lens 509. The diffraction grating 505b may be the same as or different to the diffraction grating 505a. The diffraction grating 505b recombines the deflected spectra for each output port 502. Thus, the diffraction grating 505b acts to multiplex the spectra. An imaging lens 510 images the optical signal from the diffraction grating 505b onto a beam steering optical device 511.

The beam steering optical device 511 remaps the beams incident on it to form a remapped array of beams which it directs to a second programmable deflection plane 514. The optical device 511 is positioned in the optical path between the first and second programmable deflection planes. It reverses the direction of the light of the beam incident on it. It also shifts the beam path incident on it so that the alignment of the beam path with the space switches on the second programmable deflection plane is optimised. It does this by independently controlling the spatial positioning and/or orientation of each beam from the deflected array of beams from the first programmable deflection plane in the remapped array of beams. In this way, it changes the spatial positioning and/or orientation of at least one beam from the deflected array of beams differently to at least one other beam of the deflected array of beams. The optical device may be a mirror, mirror array, freeform optic or a retroreflecting prism. Exemplary optical implementations of the optical device 511 will be described in detail below.

The remapped array of beams is then directed through two lenses 512 and 513. Lenses 512 and 513 are in a telescope arrangement, and act to image the light output from the optical device 511 onto the second programmable deflection plane 514. The telescope arrangement may be so as to magnify the remapped array of beams onto the second programmable deflection plane 514. Since the spectra have been recombined at the diffraction grating 505b, the remapped array of beams in FIG. 5 are multiplexed light signals. The second programmable deflection plane 514 acts as a column of vertical space switches 518, each of which applies a programmable deflection to each beam of the array of beams incident on it. There are the same number of space switches as there are drop ports, in this case K space switches and K drop ports. The deflection corrects for the angle each input port spectrum makes with the space switch so as to efficiently couple each multiplexed light signal to the selected output port. This ensures a directionless operation. The deflection applied by the second programmable deflection plane 514 is reconfigurable. Thus, a controller providing a control signal to the second programmable deflection plane 514 may change the deflection applied by the second programmable deflection plane 514 to each remapped beam from the beam steering optical device 511 so as to output the desired channels to the desired ports.

The light deflected from the second programmable deflection plane 514 passes through lens 515 creating a single beam at the lens array 516 for coupling to the output ports 502.

The number of angular switching positions in the spectrum channels 517 is equal to the number of output ports K. The number of switching positions in the space switches 518 is equal to the number of input ports N.

Where there are N input ports and K output ports, and K>N, N output ports may be used for direct transit from the N input ports. K-N output ports may then be used as drop ports.

FIGS. 6a and 6b illustrate a more detailed optical path for the configuration shown in FIG. 5. This includes the optical components shown in FIG. 5 and also some further optional optical components. Coupling optics 503 includes a polarisation conversion system 601. This corrects for uncertain polarisation from the input optical fibres with the coupling optics 503.

The polarisation conversion system 601 may comprise a birefringent crystal and a patterned retarder. Coupling optics 516 may also comprise a polarisation conversion system (not shown) for coupling the optical signals to the output ports in a directionless manner. This polarisation conversion system may comprise a birefringent crystal and a patterned retarder.

The beams of each of the input ports are focused at input circular focus points 602. An anamorphic converter 603 is used to convert the circular beam at input circular focus points 602 to an elongated beam focused at input anamorphic focus points 604. A large beam size improves the efficiency of the hologram zones in the switching axis y on the programmable deflection plane 508. However, a narrow width in the dispersion axis x enables the spectra to fit onto the programmable deflection plane and also maximises passband performance. Hence the anamorphic converter is used to increase the length of the light beam in the switching axis and reduce the length of the light beam in the dispersion axis, leading to the non-circular elongated shape of the light beam. The anamorphic converter 603 may comprise two anamorphic lenses. Alternatively, the anamorphic converter 603 may comprise four cylindrical lenses. An anamorphic converter 605 is positioned prior to the coupling optics 516 at the output of the switch in order to convert the light beam from an output anamorphic focus point 606 to a circular shape at output circular focus point 607 for output from the output ports. The circular shape is better matched to the shape of the output fibres. In FIGS. 6a and 6b, the anamorphic converters 603 and 605 each have an anamorphic lens having different focal lengths in the switching axis and the dispersion axis, and crossed cylindrical lenses. In the switching axis and dispersion axis the two different telescopes have a different magnitude of magnification at the same image plane.

Optionally, entrance micro-lenses 608a are located in the optical path input to the beam steering optical device 511. There is an entrance micro-lens for each input port. Optionally, exit micro-lenses 608b are located in the optical path output from the beam steering optical device 511. There is exit micro-lens for each output port. These micro-lenses 608a, 608b better transmit the light beam within the beam steering optical device 511. They are useful if the depth of field of the lens 510 is not significantly greater than the required optical length. Both the entrance and exit micro-lenses may be used. Alternatively, only one of the entrance and exit micro-lenses may be used.

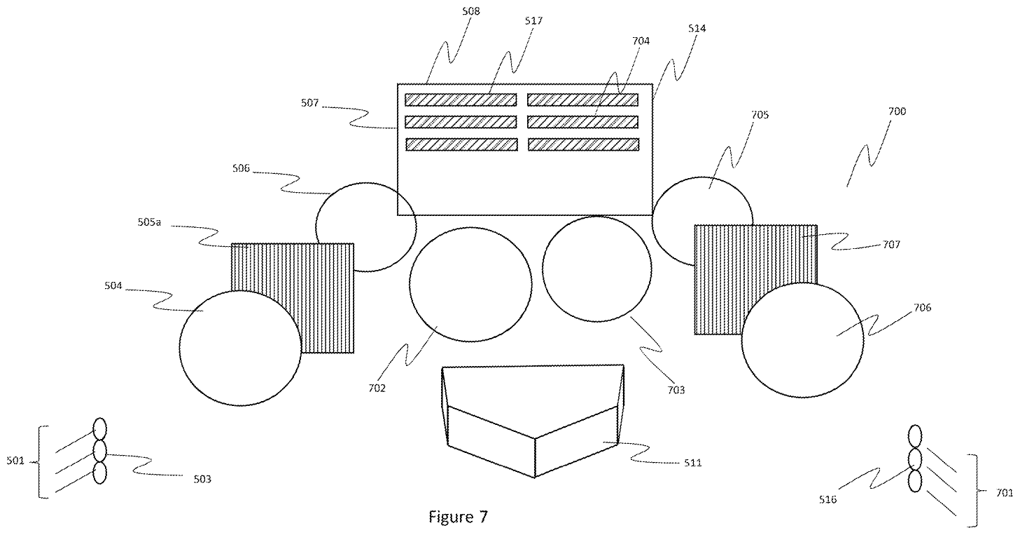

FIG. 7 illustrates an M×N WSS 700. An M×N WSS has no space switches, but instead a further set of spectra on the second programmable deflection plane. Thus, both the first and second programmable deflection planes are spectral planes configured to deflect each beam of a dispersed optical signal individually. The features of FIG. 7 which are the same as those of FIG. 5 and operate in the same manner are illustrated with the same reference numerals. The detail of those features is as described above with respect to FIGS. 5, 6a and 6b. The structure and operation of the M×N WSS differs from the description of the adWSS of FIG. 5 above by the following details.

In the M×N WSS of FIG. 7, N input ports 501 are routed to M output ports 701. The ports each have a plurality of data channels as described with respect to FIG. 5. Optical signals from the input ports 501 pass through the 4F imaging system provided by lenses 504 and 506. The optical signals are dispersed by diffraction grating 505a and form a spectra 517 on the first programmable deflection plane 508. The first programmable deflection plane deflects the optical signals incident on it as described above. The deflected array of beams is incident on a lens 702. Lens 702 is positioned so that the spectra 517 and beam steering optical device 511 are in Fourier planes. Lens 702 images the deflected spectra onto the beam steering optical device 511.

The beam steering optical device 511 remaps the deflected spectra (which are an array of beams) incident on it to form a remapped spectra (which is a remapped array of beams) which it directs to the second programmable deflection plane 514. Lens 703 is positioned between the optical device 511 and the second programmable deflection plane 514. Lens 703 images the remapped spectra from the optical device 511 onto the spectral plane 704 of the second programmable deflection plane 514.

The second programmable deflection plane 514 deflects the light incident on it such that it is deviated in a common direction. Thus, the second programmable deflection plane 514 applies a programmable deflection to each spatially separated component frequency channel beam of the remapped array of beams to form a spatially separated output array of beams. Lenses 705 and 706 are positioned in a 4F arrangement between the second programmable deflection plane 514 and the output ports 701. A diffraction grating 707 is positioned in the Fourier plane between lenses 705 and 706. The spatially separated output array of beams deflected by the second programmable deflection plane 514 passes through the lenses 705 and 706 and diffraction grating 707. Diffraction grating 707 recombines the spatially separated output array of beams for output from the switch. Thus, the diffraction grating 707 acts to multiplex the spectra to form a multiplexed array of beams for output from the switch 700. The multiplexed signals are beamed to the lens array 516 by the lenses 705 and 706. The lens array 516 couples the multiplexed signals to the output ports 701.

The first and second programmable planes may be implemented on an SLM device. Failure of that SLM device during operation may occur. If this happens and the SLM device no longer applies the programmed deflection, then a default mode may be operated in which the SLM device sends the data from the input ports to specific output ports in a “straight through” operation.

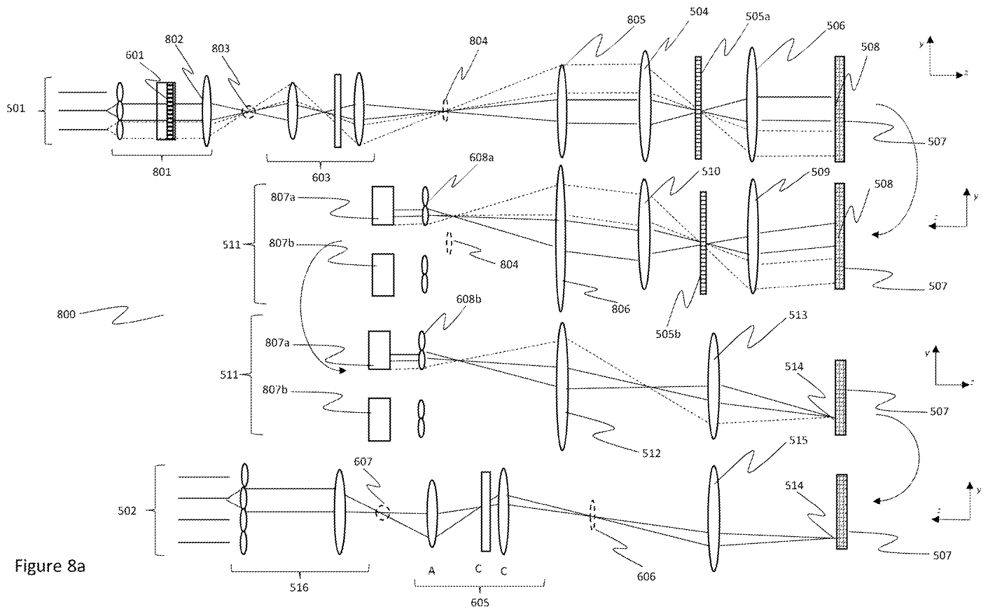

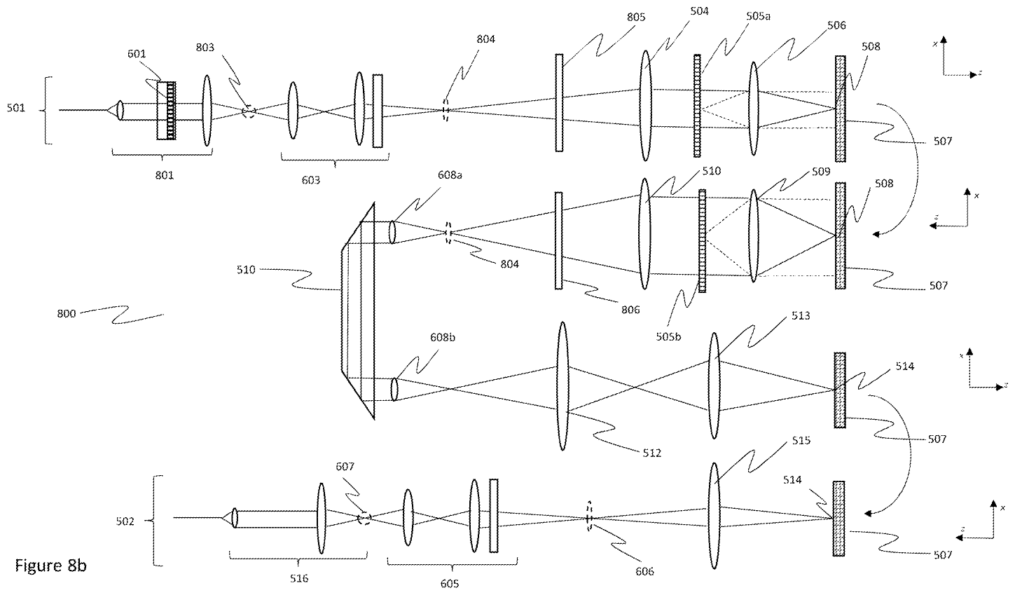

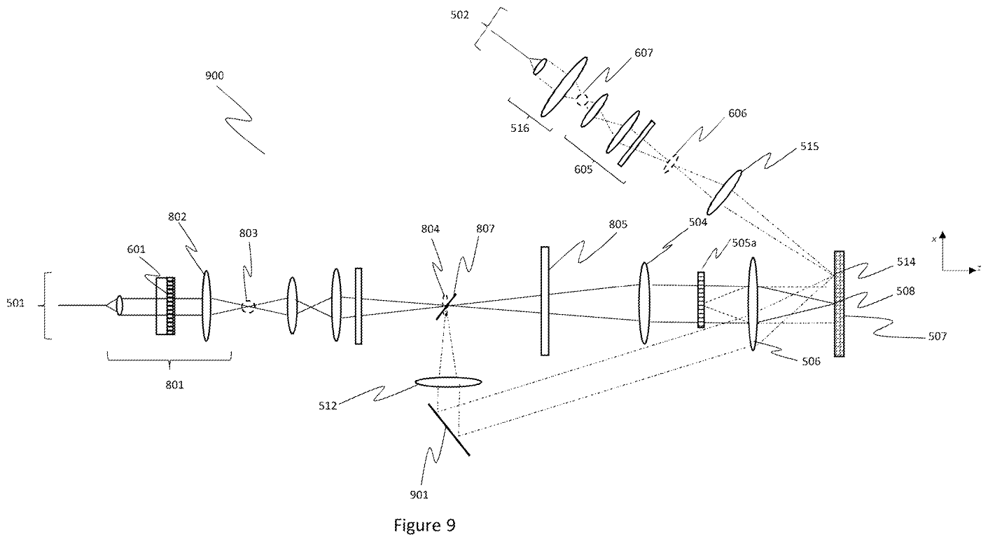

FIGS. 8a and 8b illustrate the detailed optical path of a further example of an add-drop WSS 800. FIG. 8a illustrates the path in the switching plane, i.e. the y axis shown is the switching axis and the z axis is the optical axis. FIG. 8b illustrates the optical path in the dispersion plane, i.e. the x axis shown is the dispersion axis and the z axis is the optical axis. Thus, FIG. 8b illustrates an orthogonal plane to FIG. 8a. FIG. 9 illustrates an implementation 900 of the arrangement of FIGS. 8a and 8b. The features of FIGS. 8a, 8b and 9 which are the same as those of FIGS. 5, 6a and 6b and operate in the same manner are illustrated with the same reference numerals. The detail of those features is as described above with respect to FIGS. 5, 6a and 6b. The structure and operation of the adWSS of FIGS. 8a, 8b and 9 differs from the description of the adWSS of FIGS. 5, 6a and 6b above by the following details.

The adWSS of FIGS. 8a, 8b and 9 differs from that of FIGS. 5, 6a and 6b by the use of a different telecentric 4F system for projection. This enables the beam steering optical device 511 to be positioned in the same place as the input anamorphic focus point 804 or the input circular focus point 803.

N input ports 501 are directed to coupling system 801. This coupling system comprises a polarisation conversion system 601 as described above. The beams of each of the input ports are focused at input circular focus point 803 by a single lens 802. Anamorphic correction telescope 603 converts the circular beam at input circular focus point 803 to an elongated beam at input anamorphic focus point 804. The angular encoding of the input ports in the focus at anamorphic focus point 804 is then passed through lens 805. Anamorphic focus point 804 lies in the focal plane of lens 805. Lens 805 is a cylindrical lens with optical power in the switching axis y. Lens 805 has no optical power in the dispersion axis, thus in FIG. 8b the light signal passes through the lens 805 in the dispersion plane without deviation. Lens 805 thus acts to redirect the non-dispersed light signals incident on it into spatially separated parallel non-dispersed light signals. These parallel light signals are then passed through lenses 504 and 506 in which are in a 4F arrangement. Diffraction grating 505a lies in the Fourier plane between the lenses 504 and 506. The diffraction grating disperses the light signals incident on it into spatially separated spectral channels. The dispersed array of beams from the diffraction grating are incident on the first programmable deflection plane 508.

The first programmable deflection plane 508 applies a programmable deflection to each spectral channel incident on it to form a deflected array of beams. The deflected array of beams is imaged through lenses 509 and 806 in a 4F arrangement. Diffraction grating 505b lies in the Fourier plane between lenses 509 and 510. Diffraction grating 505b multiplexes the deflected spectra incident on it to form a multiplexed signal. That multiplexed signal is then passed through cylindrical lens 806 and imaged onto beam steering optical device 511. Suitably, lenses 509 and 510 are the same as lenses 506 and 504, diffraction grating 505b is the same as diffraction grating 505a, and lens 806 is the same as lens 805.

The beam steering optical device 511 is implemented as two separate prisms 807a, 807b. Prism 807a is positioned above the input anamorphic focus point 804. Prism 807b is positioned below the input anamorphic focus point 804. The prisms 807a,807b remap the beams incident on them to form a remapped array of beams. The prisms retroreflect the light incident on them and shift it to the side such that it is output above and below the output anamorphic focus point 606 for output to output ports 502. Optionally, entrance micro-lenses 608a are located in the optical path input to the prisms 807a,807b. Optionally, exit micro-lenses 608b are located in the optical path output from the prisms 807a,807b. As in FIGS. 6a and 6b, these micro-lenses aid transmission if the depth of field of the lens 806 is not significantly greater than the required optical length.

The remapped array of beams output from the prisms 807a,807b pass through telescope lenses 512 and 513. These lenses image the remapped array of beams onto the second programmable deflection plane 514. The second programmable deflection plane 514 applies a programmable deflection to the remapped array of beams, for example by use of a hologram on axis. The remapped array of beams deflected by the second programmable deflection plane 514 propagates through lens 515 which creates a single beam at output anamorphic focus point 606. This elongated beam then passes through anamorphic telescope 605 to convert the elongated beam to a circular beam focused on output circular focus point 607. This circular signal is then coupled to a selected output port 502 by coupling optics 516.

In the implementation 900 of FIGS. 8a and 8b illustrated in FIG. 9, the light signals travel from the input ports 501 through input anamorphic focus point 804 via lenses 805, 504 and 506 and diffraction grating 505a to the first programmable deflection plane 508. The deflected array of beams deflected from the first programmable deflection plane 508 passes back through the same diffraction grating 505a and lenses 506, 504 and 805 to prisms 807.

As described above, these prisms are positioned above and below the input anamorphic focus point 804 in the switching plane. FIG. 9 illustrates the dispersion plane. The prisms 807 direct the remapped array of beams to lens 512. A mirror 901 (which is not shown in FIGS. 8a and 8b) is used in the implementation of FIG. 9 between the lens 512 and the lens 506. This mirror 901 directs the remapped array of beams from the lens 512 to the second programmable deflection plane 514 via the lens 506. In the implementation of FIG. 9, the remapped array of beams is focused onto the second programmable deflection plane 514 via the lens 506 instead of the lens 513. The array of beams deflected by the second programmable deflection plane 514 are then routed to the output ports 502 as described with respect to FIGS. 8a and 8b.

Although FIGS. 8a, 8b and 9 illustrate the prisms 807a,807b as being positioned above and below the input anamorphic focus point 804, in a further example the prisms 807a, 807b are instead positioned above and below the input circular focus point 803. In this further example, the anamorphic telescope 605 is not used.

In either the example of FIGS. 8a, 8b and 9 or the further example mentioned above, a further anamorphic telescope may be positioned between the prisms 807a,807b and the lens 512. This further anamorphic telescope is used to enable different aspect ratios of the gaussian focus at the spectra 508 and the space switches 514.

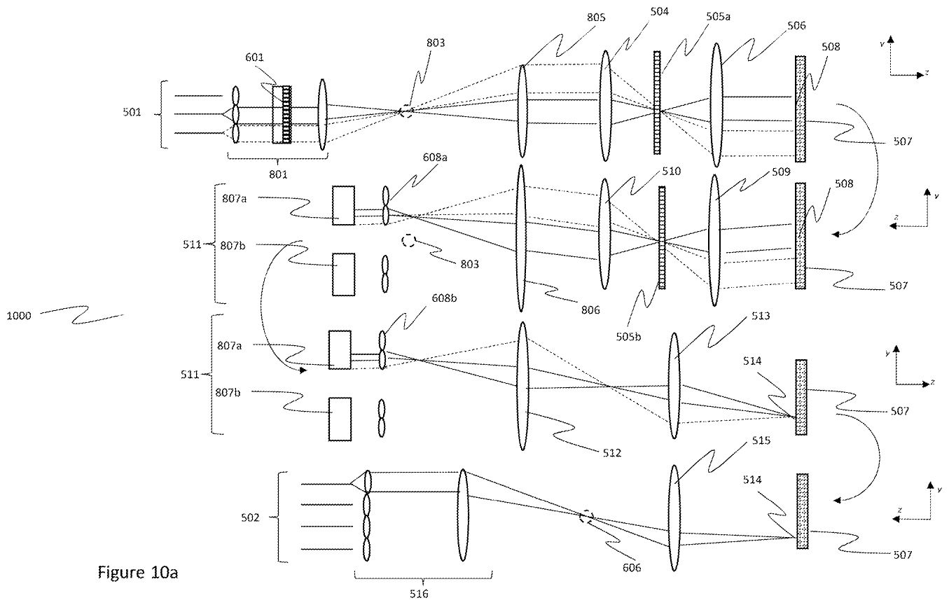

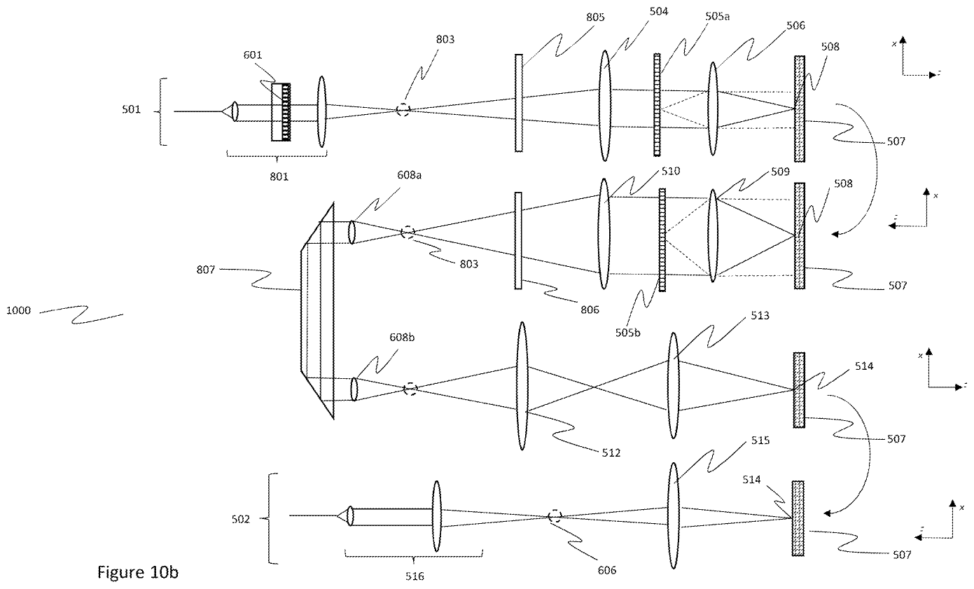

FIGS. 10a and 10b illustrate the detailed optical path of a further example of an add-drop WSS 1000. FIG. 10a illustrates the path in the switching plane, i.e. the y axis shown is the switching axis and the z axis is the optical axis. FIG. 10b illustrates the optical path in the dispersion plane, i.e. the x axis shown is the dispersion axis and the z axis is the optical axis. Thus, FIG. 10b illustrates an orthogonal plane to FIG. 10a. The features of FIGS. 10a and 10b which are the same as those of previous figures and operate in the same manner are illustrated with the same reference numerals. The detail of those features is as described above. The structure and operation of the adWSS of FIGS. 10a and 10b differs from the description above by the following details.

The adWSS of FIGS. 10a and 10b does not use anamorphic telescopes. The light focused on the input circular focus point 803 is directed straight to the lens 805. The light passes directly from the lens 515 to lens 516. The input circular focus point 803 forms the centre of the telecentric projection aligned with the two prisms 807a and 807b. The first prism 807a is located above the input circular focus point 803, and the second prism 807b is located below the input circular focus point 803.

In the example of FIGS. 10a and 10b, an asymmetric beam shape may be formed at the first and/or second programmable deflection planes. This is because the dispersion plane and the switching plane use different projections. The dispersion plane uses normal projection. The beam size in the dispersion plane is based on the width of the beam at the input circular focus point 803 in the dispersion direction. The beam size in the switching plane is determined by the divergence of the light beams at the input circular focus point 803 and the focal length of the cylindrical lens 805. Thus, an anamorphic beam may be formed by causing a larger magnitude of projection in the switching plane y compared to the dispersion plane x at the first and/or second programmable deflection planes.

In the example of FIGS. 10a and 10b, the light path at the first and second programmable deflection planes is normal to the programmable deflection planes. Thus, any aberration effects and effects from the deflection, for example caused by the SLM hologram and pixel, are minimised across the spectrum. However, the on-axis undeflected light path is not viable, and hence an output port aligned with that undeflected path is not usable.

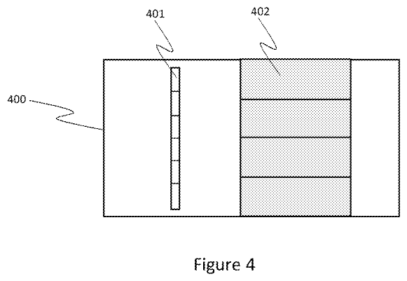

In the example described with respect to FIG. 5, the array of space switches 518 is a vertical column that maps to the vertical column of spectra 517. However, in an adWSS the number of drop ports may be significantly larger than the number of input ports. The space switches therefore take up much more vertical space on the programmable deflection plane than the spectra. Most SLM devices are rectangular in shape, and hence when the space switches and spectra are both in a column arrangement on the same SLM plane, the area of the SLM plane is not well utilised. This is shown in FIG. 4, in which a large proportion of the area of the SLM plane is not used.

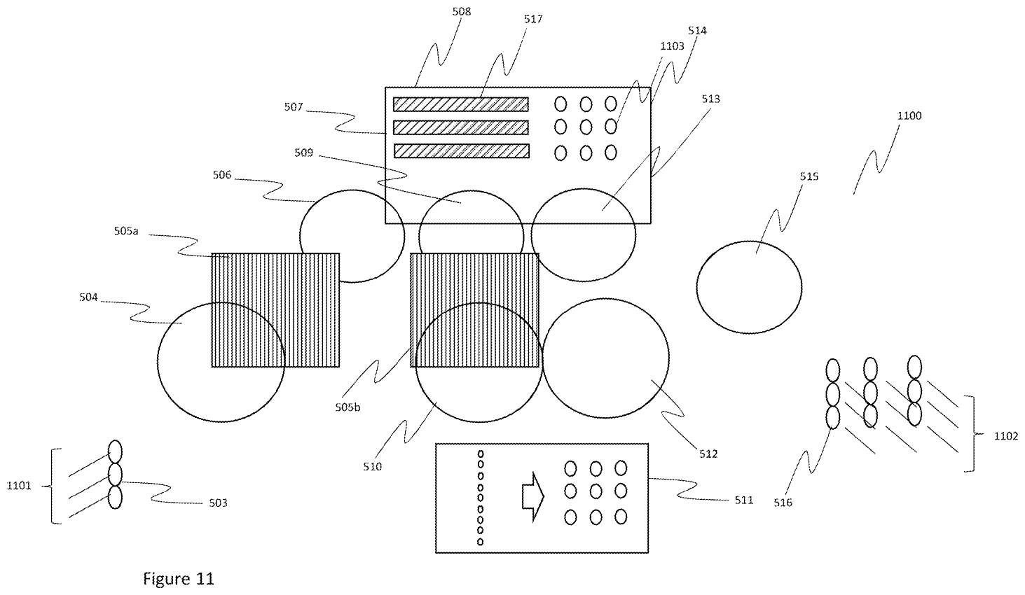

FIGS. 11, 12 and 13 illustrate examples of adWSSs in which the arrangement of the input ports is different to that of the output ports. The beam steering optical device 511 remaps the deflected array of beams from the first programmable deflection plane 508 such that the combination of the images of the beams on the first programmable deflection plane 508 and the images of the remapped array of beams on the second programmable deflection plane 514 better utilises the area of the single SLM plane 507. The beam steering optical device 511 may comprise a prism structure and/or a mirror structure that redirects the light incident on it in a controlled manner to achieve the remapping. The output ports are suitably distributed in the same way as the remapped array of beams on the second programmable deflection plane 514.

In general, the angular switching by the first programmable deflection plane 508 is perpendicular to the spectral dispersion plane. In known systems, this confines the spectra and space switches to being in vertical columns. This limits the aspect ratio of the SLM panels which can be efficiently utilised, and thereby limits the performance of the system for a given SLM specification.

The following describes examples of the beam steering optical device 511 which can be used to remap a single column spectra array on an SLM panel to a multiple column space switch array on the same or different SLM panel, so as to better utilise the area of the SLM panel(s). This is done without requiring switching of the spectra channels in the dispersion plane. Instead, the beam steering optical device 511 comprises a prism structure and/or a mirror structure which has multiple sections, each of which provides a light path for a different portion of the single column spectra array. Those light paths are different, and result in the redistribution of the portions into different columns. The multiple columns are then imaged onto the space switches which have the corresponding multiple column configuration on the SLM panel.

The following also describes examples of the beam steering optical device 511 which can be used to remap multiple spectra columns on an SLM panel to a single vertical column space switch array on the same or different SLM panel, so as to better utilise the area of the SLM panel(s). In the case of multiple spectra columns, switching can only be done perpendicular to the dispersion plane. In doing so with lenses only, not all space switches can be accessed by all the spectra channels. However, the beam steering optical device 511 comprises a prism structure and/or a mirror structure which has multiple sections, each of which provides a light path for the different columns of the multiple spectra columns. Those light paths are different, and result in the redistribution of the multiple columns into a single vertical column. The redistributed array is then passed through a lens to convert the redistributed array in the conjugate space switch plane, and imaged onto the space switches which have the corresponding single vertical column configuration on the SLM panel.

The features of FIGS. 11, 12 and 13 which are the same as those of FIG. 5 and operate in the same manner are illustrated with the same reference numerals. The detail of those features is as described above with respect to FIGS. 5, 6a and 6b. The structure and operation of the adWSSs of FIGS. 11, 12 and 13 differs from the description of the adWSS of FIG. 5 by the following details.

In FIG. 11, the input ports 1101 are arranged in a column array and the output ports 1102 are arranged in a grid array. The coupling lenses 503 match the distribution of the input ports 1101. The lens array 516 matches the distribution of the output ports 1102. The dispersed optical signals form spectra 517 on the first programmable deflection plane 508 in the same manner as described with respect to FIG. 5. The deflected array of beams from the first programmable deflection plane 508 is in the same conformal shape as the arrangement of the input ports, i.e. a column array in this example. The deflected array of beams from the first programmable deflection plane 508 travels through a lens 509 and diffraction grating 505b in the Fourier plane of lens 509. The diffraction grating 505b recombines the deflected spectra for each output port. An imaging lens 510 images the optical signal from the diffraction grating 505b onto the beam steering optical device 511. The beam steering optical device 511 remaps the deflected array of beams such that the remapped array of beams directed towards the second programmable deflection plane 514 matches the conformal shape of the output ports 1102. The space switches 1103 on the second programmable deflection plane 514 match the conformal shape of the output ports. The arrangement of the space switches 1103 matches the conformal shape of the remapped array of beams. Thus, the optical device 511 remaps the vertical column of deflected beams input to it to a two-dimensional array of beams for imaging onto the space switches 1103 via the telescopic lenses 512 and 513. The space switches 1103 then deflect the remapped array of beams to the output ports 1102 via lens 515 and coupling ports 516.

The beam steering optical device may be implemented as a passive or active (i.e. electrically switchable) component. For example, a prism, mirror array, catadioptric system, freeform lens and mirror, a diffractive optical element, a diffractive optical element array, a holographic optical element, a holographic optical element array, a MEMS array or LCOS may be implemented. The MEMS array may be a DLP® (Digital Light Processing) MEMS array. The LCOS may be a Liquid Crystal based active beam steerer using switchable micro lenses.

Although the input ports 1101 are shown in a vertical column array, a different conformal arrangement of input ports may be used. For example, the input ports 1101 may be arranged as multiple columns. However, the spectra formed on the first programmable deflection plane must not overlap.

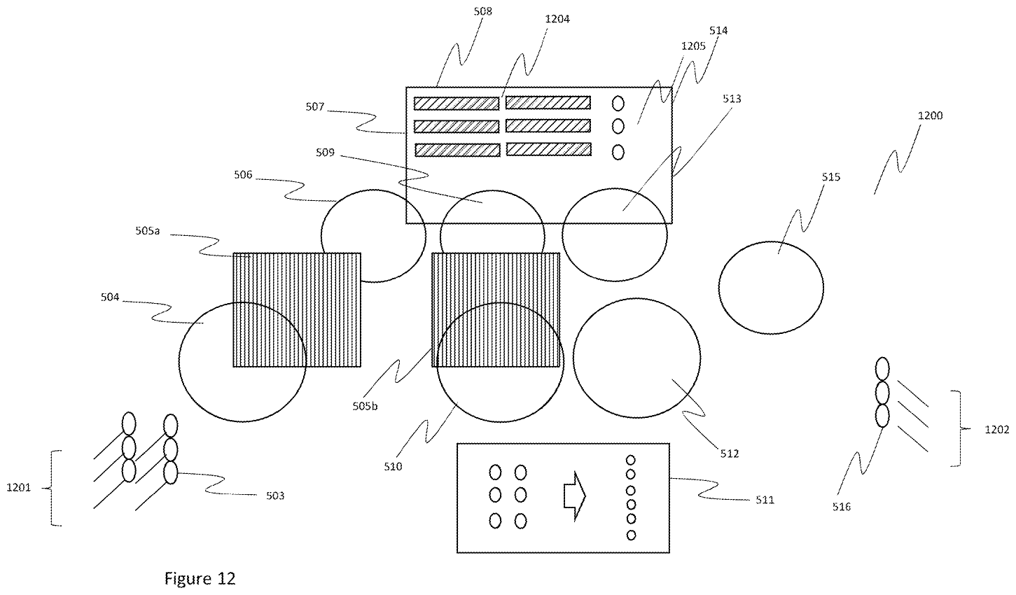

In FIG. 12, the input ports 1201 are arranged in a grid array and the output ports 1202 are arranged in a column array. The coupling lenses 503 and 516 are as described above with respect to FIG. 11. The input ports shown are in two columns. Thus, two columns of spectra 1204 are imaged onto the first programmable deflection plane 508. These two columns of spectra are re-multiplexed through the 4F arrangement of lenses 509 and 510 separated by diffraction grating 505b. The deflected re-multiplexed spectra array having two columns is remapped by the optical device 511 to a one-dimensional column array. This remapped single column array of beams is directed to the second programmable deflection plane. In this example, the optical device 511 is a converter retroreflecting optical device. It allows access from all spectra on the first programmable deflection plane 508 to any space switch on the second programmable deflection plane 514 without requiring deflection in the dispersion axis of the spectra 1204. In this example, lenses 512 and 513 are a conjugate converter instead of the imaging telescope of FIG. 11. The space switches on the second programmable deflection plane 514 have the same column arrangement as the remapped array of beams. Thus the space switches deflect the remapped array of beams to the output ports 1202 via lens 515 and coupling ports 516.

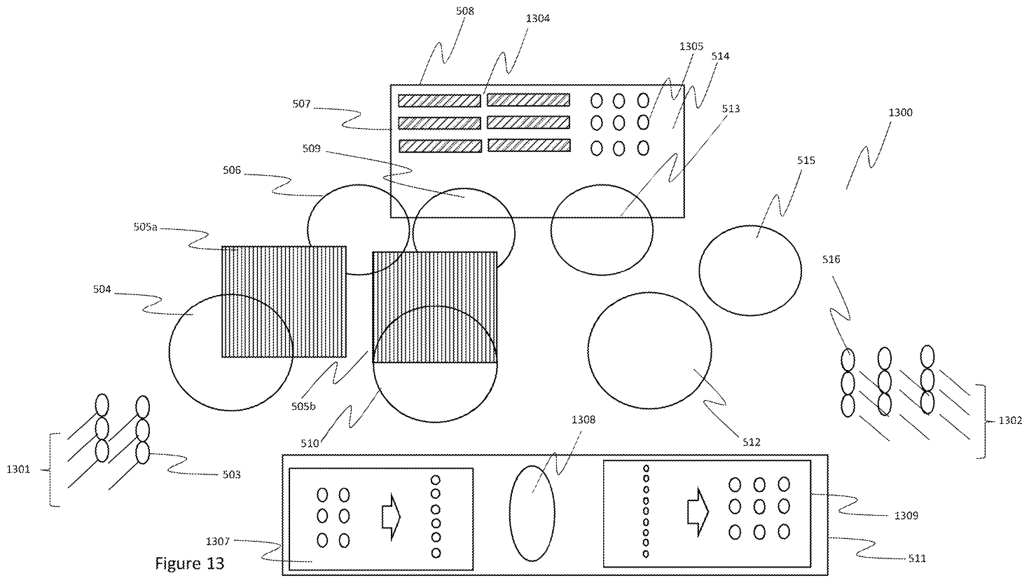

In FIG. 13, the input ports 1301 are arranged in a grid array and the output ports 1302 are arranged in a different grid array. The coupling lenses 503 and 516 are as described above with respect to FIG. 11. The input ports shown are in two columns. Thus, two columns of spectra 1304 are imaged onto the first programmable deflection plane 508. These two columns of spectra are re-multiplexed through the 4F arrangement of lenses 509 and 510 separated by diffraction grating 505b. The deflected re-multiplexed spectra array having two columns is remapped by the optical device 511 to an array having three columns to match the array of output ports. Optical device 511 comprises optical parts 1307 and 1309 and lens 1308. First, optical part 1307 of optical device 511 converts the two column array of deflected beams from the first programmable deflection plane 508 to a column array. This column array is then passed through conjugate Fourier lens 1308 to second optical part 1309. Second optical part 1309 converts the column array to a three column array matching the array of space switches on the second programmable deflection plane 514. This three column array is then imaged by telescopic lenses 512 and 513 to the space switches 1305 on second programmable deflection plane 514. Thus the space switches deflect the remapped array of beams to the output ports 1302 via lens 515 and coupling ports 516.

The constituent optical parts 1307 and 1309 and lens 1308 may be separate components. Alternatively, 1307, 1309 and 1308 may be a single component.

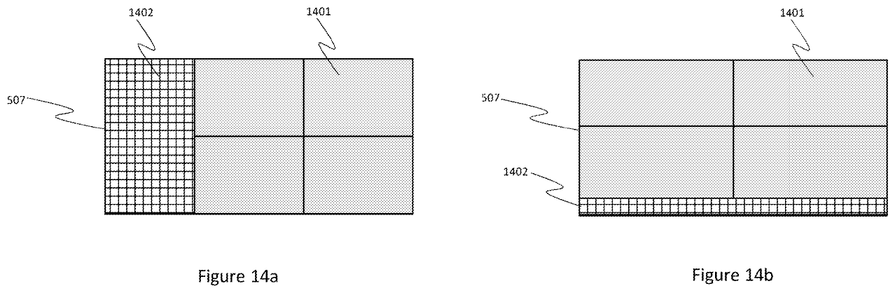

The examples of FIGS. 11, 12 and 13 show that the arrangement of the individual space switches relative to the spectral planes can be remapped in order to better utilise the available space on the SLM panel. FIGS. 14a and 14b illustrate two examples in which the space switches have been redistributed in order that the spectra 1401 and space switches 1402 utilise a larger proportion of the area of the SLM panel 507 than in the prior art (see FIG. 4). In both examples, both the spectra 1401 and space switches 1402 are in 2D arrays. This allows more space switches to be used for the same size of SLM panel compared to known devices. Additionally, this allows a greater height of spectra compared to known devices, thereby allowing more switchable positions. Thus, the capacity of the WSS increases for the same SLM panel area. In FIG. 14a, the space switches and spectra are side by side. In FIG. 14b, the space switches are below the spectra. Any combination of the space switches and spectra may be created using the remapping described herein. Suitably, the images on the first programmable deflection plane and the images of the remapped array of beams on the second programmable deflection plane cover over 80% of the area of the SLM panel. The images of the first programmable deflection plane and the remapped array of images on the second programable deflection plane may cover the whole area of the SLM panel.

FIGS. 14a and 14b illustrate the SLM panel in a landscape orientation. This enables wide spectra which leads to better passband performance and greater total bandwidth than if narrower spectra were required due to an SLM panel being used in a portrait orientation.

However, an SLM panel in a portrait orientation may be utilised with any of the examples described herein.

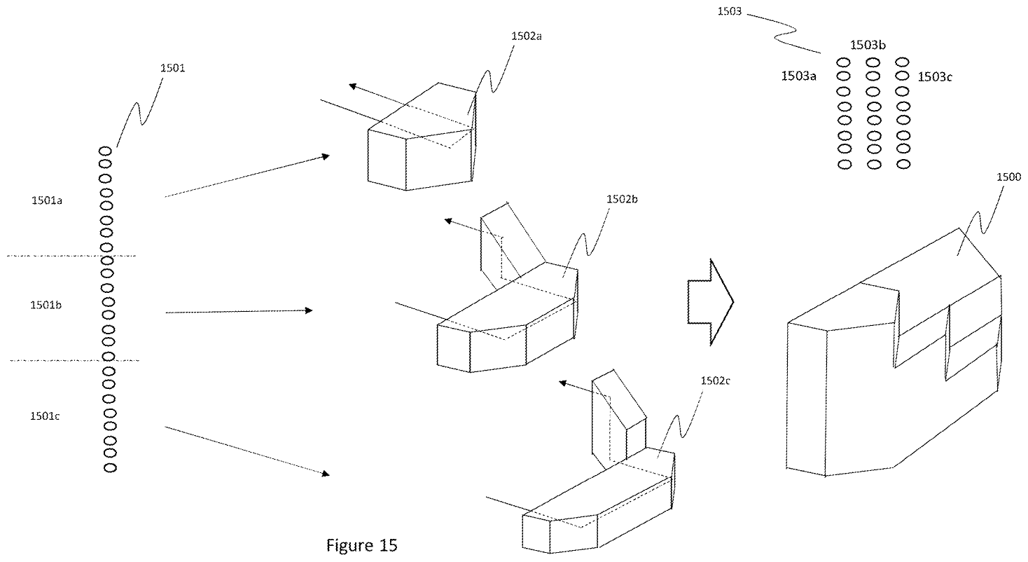

FIGS. 15, 16, 17 and 18 illustrate some implementations of the beam steering optical device 511. Each beam steering optical device remaps an array of points incident on it into a different conformal pattern. That different conformal pattern matches the geometrical distribution of the space switches on the second programmable deflection plane and the geometrical distribution of the image of the set of output ports on the second programmable deflection plane. The beam steering optical device of FIG. 15 is a prism array 1500. The prism array 1500 remaps a single column array of beams to a multiple column array of beams, as shown in FIG. 11. Referring to FIGS. 11 and 15, the single column of spectra 517 are deflected by the first programmable deflection plane 508 and combined by the diffraction grating 505b. They are then imaged by lens 510 to form a set of column points 1501 at the entrance to the prism 1500. Microlenses 608a may optionally be used to collimate the light at the entrance of the prism 1500, as described above. The prism array 1500 remaps the column points 1501 to a grid of points 1503.

The prism array 1500 splits the column points 1501 into groups. FIG. 15 illustrates three groups 1501a, 1501b, 1501c, however it will be understood that more or fewer groups may be used. Group 1501c is underneath group 1501b which is underneath group 1501a in the single column of points 1501. Each group of points 1501a, 1501b, 1501c is directed to a different retroreflecting structure. Group 1501a is incident on structure 1502a, and exits structure 1502a as group 1503a. Group 1501b is incident on structure 1502b, and exits structure 1502b as group 1503b. Group 1501c is incident on structure 1502c, and exits structure 1502c as group 1503c. Prism structure 1502a causes group 1503a to be displaced to the side relative to group 1501a. Prism structure 1502b incorporates a periscope prism transmission which causes group 1503b to be displaced vertically relative to group 1501b. Prism structure 1502b also causes group 1503b to be displaced to the side relative to group 1501b. Thus, group 1503b is a different column of points to group 1503a which is positioned next to group 1503a. Prism structure 1502c causes group 1503c to be displaced to the side relative to groups 1503c. Prism structure 1502c incorporates a periscope prism transmission which causes group 1503c to be displaced vertically relative to group 1501c. Prism structure 1502c also causes group 1503c to be displaced to the side relative to group 1501c. Thus, group 1503c is a different column of points to groups 1503a and 1503b which is positioned next to group 1503b. In this way, the single column of points 1501 is remapped to a two-dimensional array of columns 1503.

Prism structures 1502a, 1502b and 1502c are non-overlapping and may be part of a single passive prism element.

If micro lenses 608a, 608b are not used, then the optical path through each prism structure for each group is altered such that the total optical path length for each group is the same. This ensures that focussing in the subsequent lens systems 512 and 513 would focus all the beams onto the second programmable deflection plane 514.

The prism array 1500 of FIG. 15 may be used as each of the prisms 807a, 807b described with respect to FIGS. 8a and 8b. An area between the prisms 807a, 807b is clear or transparent with no optical power so as to allow transmission of the input focus point 804 or 803.

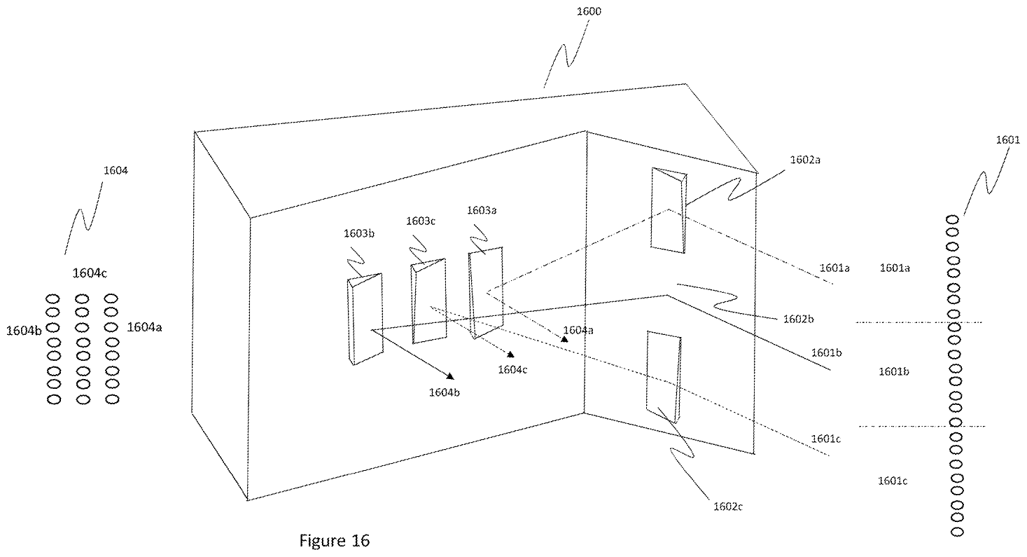

The beam steering optical device of FIG. 16 is a mirror array 1600. The mirror array 1600 remaps a single column of points 1601 incident on it to a grid of points 1604. The mirror array 1600 splits the column points into groups. FIG. 16 illustrates three groups 1601a, 1601b, 1601c, however it will be understood that more or fewer groups may be used. Group 1601c is underneath group 1601b which is underneath group 1601a in the single column of points 1601. Each group of points 1601a, 1601b, 1601c follows a different optical path through the mirror array 1600. Each group of points reflects off a pair of mirror surfaces. Group 1601a reflects off mirror pair 1602a and 1603a as it passes through the mirror array 1600, exiting the mirror array 1600 as group 1604a. Group 1601b reflects off mirror pair 1602b and 1603b as it passes through the mirror array 1600, exiting the mirror array 1600 as group 1604b. Group 1601c reflects off mirror pair 1602c and 1603c as it passes through the mirror array 1600, exiting the mirror array 1600 as group 1604c. Each mirror surface of a pair of mirror surfaces are angled with respect to each other. The angle between the pair of mirror surfaces for each group of points is different. Thus, each group of points follows a different path through the mirror array 1600 thereby causing the geometrical distribution of the groups of points to change. Thus, mirror pair 1602a and 1603a causes group 1604a to be displaced to the side relative to group 1601a. Mirror pair 1602c and 1603c causes group 1604c to be displaced vertically relative to group 1604c, and also displaced to the side relative to group 1601c. Thus, group 1604c is a different column of points to group 1604a which is positioned next to group 1604a. Mirror pair 1602b and 1603b causes group 1604b to be displaced to the side relative to group 1601b, and also displaced vertically relative to group 1601b. Thus, group 1604b is a different column of points to groups 1604a and 1604c which is positioned next to group 1604c. In this way, the single column of points 1601 is remapped to a two-dimensional array of columns 1604.

A high depth of field, micro-lenses 608a, 608b or optical corrector plates may additionally be used to minimise the difference in optical paths between the groups 1604a, 1604b, 1604c. This ensures that all the beams focus onto the second programmable deflection plane 514 after passing through subsequent lens systems 512 and 513.

The examples of FIGS. 15 and 16 describe converting a column array into a grid array. It will be understood that inverting the described structures enables a grid array to be converted to a column array.

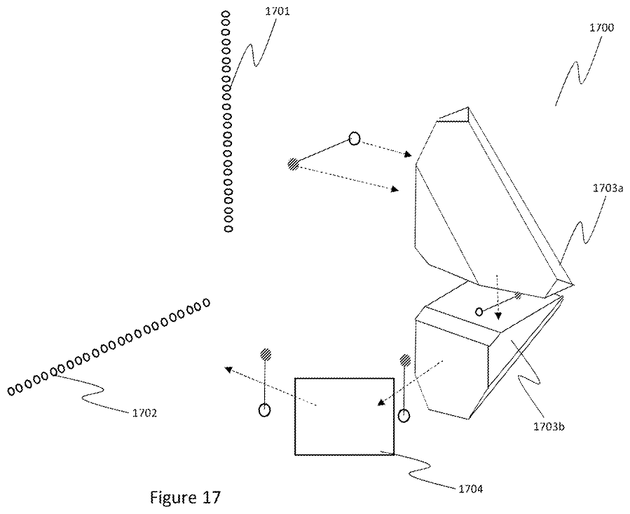

The beam steering optical device of FIG. 17 is a prism 1700. The prism 1700 remaps a single column array 1701 by rotating it by 90° to form a row array 1702. Prism 1700 comprises two orthogonal Amici Roof prisms 1703a and 1703b. If the beam steering optical device is to retroreflect the beam array, as in the examples of FIGS. 11 and 12, then the prism 1700 includes a retroreflecting mirror 1704 at the output of the Amici Roof prisms. If the beam steering optical device is not to retroreflect the beam array, as in the example of FIG. 13, then the prism 1700 does not include a retroreflecting mirror.

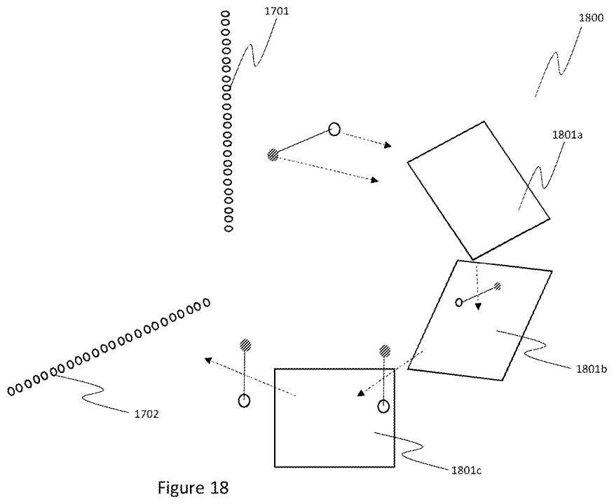

The beam steering optical device of FIG. 18 is an array of mirrored surfaces 1800. The mirrored surface array 1800 remaps a single column array 1701 by rotating it by 90° to form a row array 1702. Mirrored surface array 1800 comprises three differently angled reflecting surfaces 1801a, 1801b and 1801c. These mirrored surfaces may be separate mirrors. Alternatively, the mirrored surfaces may be total internal reflection planes in a prism.

Although FIGS. 17 and 18 only illustrate a single column array 1701 which is rotated to form the row array 1702, an array input to either device 1700 or device 1800 may comprise multiple columns. In this case, each column is rotated by 90° to form a row array. Thus, a two-dimensional array having X columns is remapped to a two-dimensional array having X rows.

The beam steering optical device implementations shown in FIGS. 17 and 18 can be used to redistribute space switches above or underneath the spectra on an SLM plane, as shown in FIG. 14b.

In each of the beam steering optical devices described with respect to FIGS. 15, 16, 17 and 18, the beam steering optical device remaps the deflected array of beams from the first programmable deflection plane by causing them to undergo two individual refractions, reflections or diffractions. The deflected array of beams has been transposed in two orthogonal directions. The deflected array of beams may have a linear distribution and the remapped array of beams a non-linear distribution. Alternatively, the deflected array of beams may have a non-linear distribution and the remapped array of beams a linear distribution. Alternatively, the deflected array of beams may have a non-linear distribution, and the remapped array of beams a different non-linear distribution. Alternatively, the deflected array of beams may have a linear distribution, and the remapped array of beams a different linear distribution, or a similar linear distribution but oriented in a different direction.

All of the examples described herein are directionless. Thus, they can operate in reverse. In other words, in each of the examples described above, light may enter the switch through the ports described as the output ports, and then travel through the internal structure of the switch in the reverse order to that described above, and leave the switch through the ports described as the input ports. For the adWSSs, this means light enters the switch via K add ports (the same as the output drop ports described above) and leaves via N output ports (the same as the input ports described above). When a switch is operated in reverse to that described above, reciprocal control of the first and second programmable deflection planes is used. When operated in reverse, the light is first deflected by the second programmable deflection plane 514 described above, then routed via the beam steering optical device 511 to the first programmable deflection plane 508 before being output from the switch via the output ports.

Although the WSS examples described above all include spectra on a programmable deflection plane, the same beam steering optical device 511 may instead be used to remap an array of space switches on a first programmable deflection plane to a remapped array of space switches on a second programmable deflection plane. This enables a geometrical configuration of input ports to be mapped to a different geometrical configuration of output ports. All the channels in an input port are mapped to all the channels in an output port. In this case, no diffraction gratings are required in the switch.

The WSS devices described herein utilise a beam steering optical device 511 to remap the deflected array of beams from the first programmable deflection plane such that the remapped array of beams can be imaged (for example by magnification) so that it better utilises the area of the second programmable deflection plane. When the first and second programmable deflection planes are on the same SLM panel, this means that the distribution of spaces switches and/or spectra of each programmable deflection plane efficiently covers the area of the SLM panel. This enables multiple WSSs to use the same SLM panel. When the first and second programmable deflection planes are on separate SLM panels, the remapping performed by the beam steering optical device 511 enables a smaller or cheaper second SLM to be used for the second programmable deflection plane.

SLM panels are generally rectangular. Thus, the remapping described herein usefully changes the conformal structure of the deflected beams from the first programmable deflection plane from a column distribution to another column distribution or a grid distribution. However, the beam steering optical devices described herein independently control the spatial positioning and/or orientation of each beam from the deflected array of beams in the remapped array of beams. Thus, each beam is remapped independently of every other beam in the deflected array. This remapping is in two dimensions. This enables the overall distribution of the deflected array to be remapped to any distribution. That remapped distribution may be linear or non-linear. It may be columnar in shape. It may have a non-column shape. For example, the remapped distribution may be hexagonal. Thus, any shaped SLM panel, be it rectangular, non-rectangular or irregular shaped can be better filled utilising the beam steering optical devices described herein. The ability to remap to any configuration allows flexibility in the LCOS aspect ratio to meet a particular design target. Switching in one or two dimensions can be implemented.

It is also noted that the deflected array of beams input to the beam steering optical devices described herein need not be in a column arrangement. A non-column distribution of beams can be input to the beam steering optical device and it remap that non-column distribution of beams into whatever distribution of beams is needed for the second programmable deflection plane, be that a column arrangement or not.

The remapping performed by the beam steering optical device may be controlled so as to generate a distribution of spectra/space switches on the second programmable deflection plane which improves the coupling of light to the output ports, for example by reducing crosstalk.

The examples described herein utilise one-dimensional angular deviation at the first programmable deflection plane in a direction normal to the dispersion plane. Angle switching in the dispersion plane is not required. However, angular deviation in the dispersion plane may also be implemented at the first programmable deflection plane. A small dispersion axis shift on the spectra creates multiple columns. This may be used if a non-column arrangement is desired for the remapped array of beams output from the beam steering optical device. By incorporating a small dispersion axis shift, the maximum angle required for a given number of ports reduces.

The beam steering optical devices described herein remap the deflected array of beams from the first programmable deflection plane. For an adWSS, the image of the re-multiplexed spectra and space switches are in conjugate planes since the space switches are chosen by altering the angle in the spectral plane. Thus, the conjugate plane must be changed on reflection. At least one imaging element between the spectral plane and the space switch plane is in the conjugate configuration. This imaging element may be a lens or mirror. This imaging element may form part of the beam steering optical device or be separate from it. The same applies for a M×N switch.

It is preferable to minimise the number of distinct components in the switch and for the construction and layout of those components to be as simplified as possible. This enables the switch to be more compact and more straightforward to manufacture.

The examples described above utilise a “fan-in” approach for imaging the input ports onto the first programmable deflection plane. A fan-in approach is one in which the optical signals from the input ports are brought to a common point focus before reaching the first programmable deflection plane. In the examples described above this point focus is the input circular focus point or the input anamorphic focus point.

The examples described below additionally utilise a “fan-out” approach, in which the optical signals from the second programmable deflection plane are brought to a common point focus before reaching the output ports. It is known to use a fan-in or a fan-out approach, but not both, for the reason explained below. A fan-in approach, as described in the examples above, is preferred to a fan-out approach because this uses fewer components overall in the switch. However, utilising both a fan-in and fan-out approach enables optimum operation for the single SLM device which comprises the first and second programmable deflection planes. It also enables fewer, simpler components to be used in the switch which leads to a more compact switch which is easier to manufacture.

In the optical path between the first and second programmable deflection planes there is an image plane of the first programmable deflection plane and an image plane of the second programmable deflection plane which are in conjugate planes. There is spatial data in both of these conjugate planes. Because of this, in the examples described above, there is no simple plane between the first and second programmable deflection planes in which the optical signals come to a single focus point.

The examples below describe modifications to the internal components of the switches described above to enable both a fan-in and fan-out approach to be used. In these examples, a gap is created in the conjugate image plane of the first programmable deflection plane between a first group of beams projected on that conjugate image plane by the first programmable deflection plane and a second group of beams projected on that conjugate image plane by the first programmable deflection plane. The second programmable deflection plane deviates all the optical signals incident on it towards the output ports through the gap in this conjugate plane. Thus, the switch implements a fan-out procedure as well as a fan-in procedure.

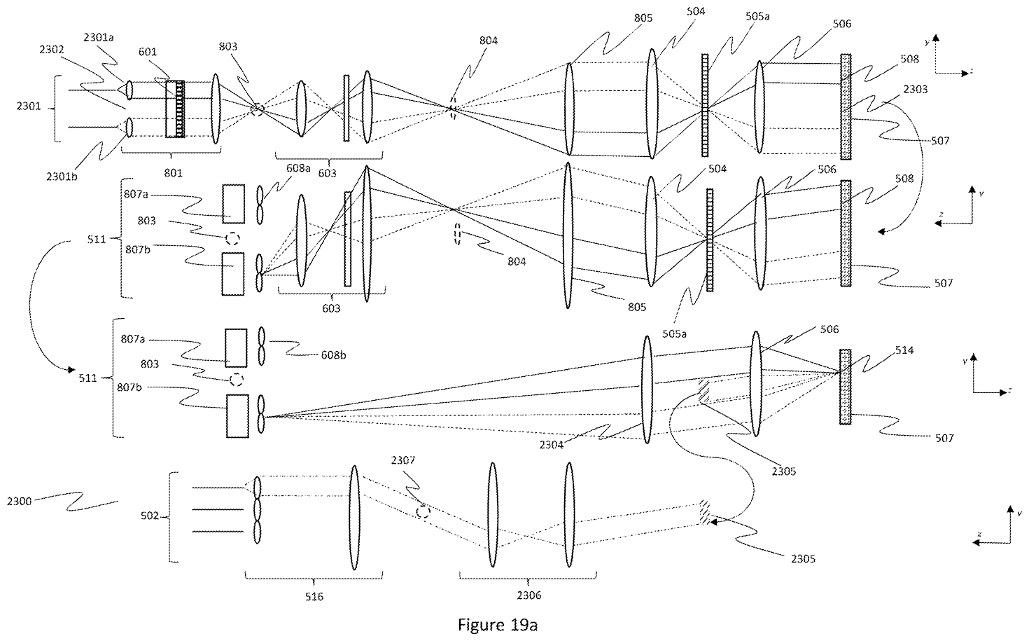

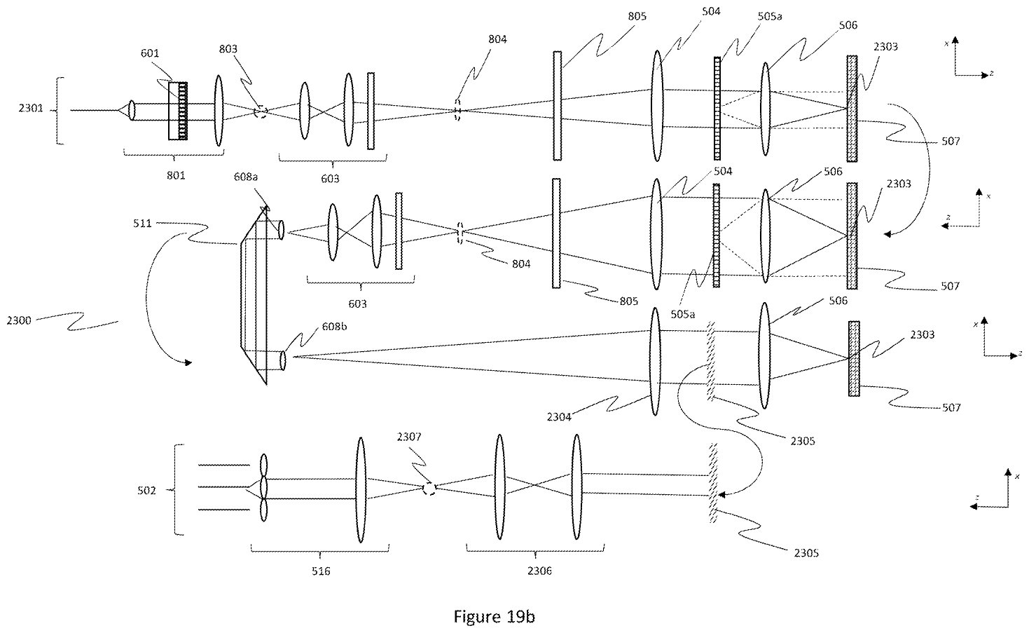

FIGS. 19a and 19b illustrate the detailed optical path of an exemplary add-drop WSS 2300. FIG. 19a illustrates the path in the switching plane, i.e. the y axis shown is the switching axis and the z axis is the optical axis. FIG. 19b illustrates the optical path in the dispersion plane, i.e. the x axis shown is the dispersion axis and the z axis is the optical axis. Thus, FIG. 19b illustrates an orthogonal plane to FIG. 19a. The features of FIGS. 19a and 19b which are the same as those of FIGS. 8a and 8b and operate in the same manner are illustrated with the same reference numerals. The detail of those features is as described above with respect to FIGS. 8a and 8b. The structure and operation of the adWSS of FIGS. 19a and 19b differs from the description of the adWSS of FIGS. 8a and 8b above by the following details.

The input ports 2301 of FIGS. 19a and 19b are different to those of FIGS. 8a and 8b. The input ports 2301 are distributed such that there is a gap in the beams incident on the first programmable deflection plane 508 from the input ports 2301. This gap may be generated by removing one or more ports from the set of input ports 501 of the example of FIGS. 8a and 8b. Alternatively, this gap may be generated by altering the arrangement of input ports 501 of the example of FIGS. 8a and 8b. The set of input ports 2301 thus comprises a first set of input ports 2301a and a second set of input ports 2301b. The first set of input ports 2301a is spatially separated from the second set of input ports 2301b by a spacing 2302, so as to form a gap between those beams incident on the first programmable deflection plane 508 from the first set of input ports 2301a and those beams incident on the first programmable deflection plane 508 from the second set of input ports 2301b.

The light signals propagate from the input ports 2301 to the first programmable deflection plane 508 as described with reference to FIGS. 8a and 8b. The light incident on the first programmable deflection plane is normal to the first programmable deflection plane. This minimises insertion loss and utilises the best operation of the first programmable deflection plane, particularly in the case that the first programmable deflection plane is an LCOS device.

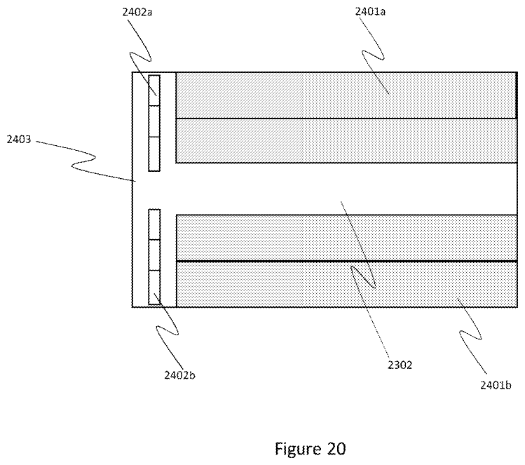

FIG. 20 illustrates the arrangement of spectra and space switches in the case that the switch is an adWSS and both the first and second programmable deflection planes are implemented on a single SLM device. The spectra 2401 are arranged in a first group 2401a and a second group 2401b. The first and second groups of spectra are separated by gap 2302. This gap is shown as centrally located on the first programmable deflection plane. However, it could be located elsewhere on the first programmable deflection plane. In this example, the gap 2302 is the same size as a spectrum. It is not formed by splitting any of the spectra. The spectral distribution on the first programmable deflection plane 508 of FIGS. 19a and 19b is therefore different to that shown in FIGS. 14a and 14b. Although shown as a landscape arrangement, it will be understood that the SLM device may be arranged in a portrait arrangement or have a non-rectangular shape, as described above.

In FIG. 20, the gap 2302 is an inactive area on the single SLM. Alternatively, the gap 2302 may be used to accommodate space switches. Suitably, these space switches have been remapped to be located in the gap by the beam steering optical device 511 described above. Alternatively, if the first programmable deflection plane is implemented on a first SLM device, and the second programmable deflection plane implemented on a second SLM device, then the gap 2302 may be a gap between the first and second SLM devices.

The first programmable deflection plane 508 applies a programmable deflection to each spectral channel incident on it to form a deflected array of beams. The deflected array of beams comprises a first set of deflected beams separated from a second set of deflected beams by a gap. The deflected array of beams is imaged back through the same lenses 506 and 504 in the 4F arrangement. The deflected array of beams passes through the same diffraction grating 505a. Diffraction grating 505a multiplexes the deflected spectra incident on it to form a multiplexed signal. The multiplexed signal passes through the same cylindrical lens 805. The multiplexed signal is focussed to a point above the input anamorphic focus point 804. The multiplexed signal then passes through anamorphic correction telescope 603 to beam steering optical device 511.

Beam steering optical device 511 is optional in this WSS, but if incorporated operates as described in any of the examples above.

The beams output from the beam steering optical device 511 are still in two groups separated by a gap. These beams then pass through lenses 2304 and 506 in a telescope arrangement for focussing on the second programmable deflection plane 514. The optical signal incident on the second programmable deflection plane is normal to the second programmable deflection plane.

Referring to FIG. 20, the space switches 2402 are arranged in a first group 2402a and a second group 2402b. The first and second groups of space switches are separated by gap 2403. This gap is shown as centrally located on the second programmable deflection plane. However, it could be located elsewhere on the second programmable deflection plane. This gap 2403 is not required to enable the switch to implement a fan-out arrangement. However, implementing a gap on both the first and second programmable deflection planes simplifies the optics in the remainder of the switch.

Referring back to FIG. 19a, the second programmable deflection plane 514 applies a programmable deflection to each of the first and second sets of beams incident on it. The deflection applied by the second programmable deflection plane 514 is so as to direct all the beams incident on it to a gap in the beams projected on a conjugate image plane of the first programmable deflection plane. The beams projected on this image plane from the first programmable deflection plane include a first set of deflected beams and a second set of deflected beams separated by the gap. The deflected first and second sets of beams from the second programmable deflection plane 514 pass through lens 506 and onto mirror 2305 located in the gap.

Mirror 2305 is located in the optical path between the first and second programmable deflection planes. Mirror 2305 is located in the optical path between the second programmable deflection plane and the output ports. Mirror 2305 is located where the gap is between the first and second sets of deflected beams. Mirror 2305 is located in the focal plane of lens 506. Mirror 2305 is also located in the focal plane of lens 2304. The mirror 2305 is angled so as to deflect the deflected first and second sets of beams from the second programmable deflection plane 514 towards the set of output ports. The mirror 2305 directs the deflected beams towards telescope 2306. Telescope 2306 may be implemented as two lenses. Telescope 2306 adjusts the magnification to a focus plane 2307. The magnified deflected beams are then coupled to a selected output port 502 by coupling optics 516. The output port 502 selected is determined by the angle of deflection from the second programmable deflection plane as described above.

The lens 506 is in the optical path four times in this WSS: between the input ports and the first programmable deflection plane, between the first programmable deflection plane and the beam steering optical device, between the beam steering optical device and the second programmable deflection plane, and between the second programmable deflection plane and the output ports.

Although structure 2305 has been described herein as a mirror, it may alternatively by any other suitable beam steering device. For example, structure 2305 may be any of a mirror, mirror array, prism total internal reflection surface, diffractive optical element and holographic optical element.

The implementation described with reference to FIGS. 19a and 19b is simple to implement. However, the SLM area is not as efficiently used by virtue of the unused area of the gap 2302.

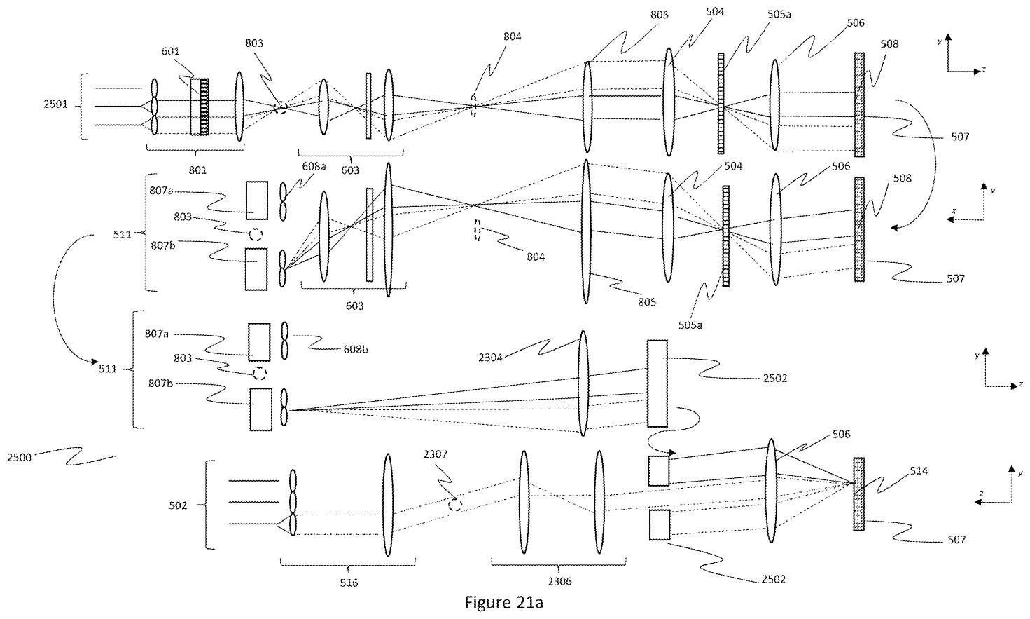

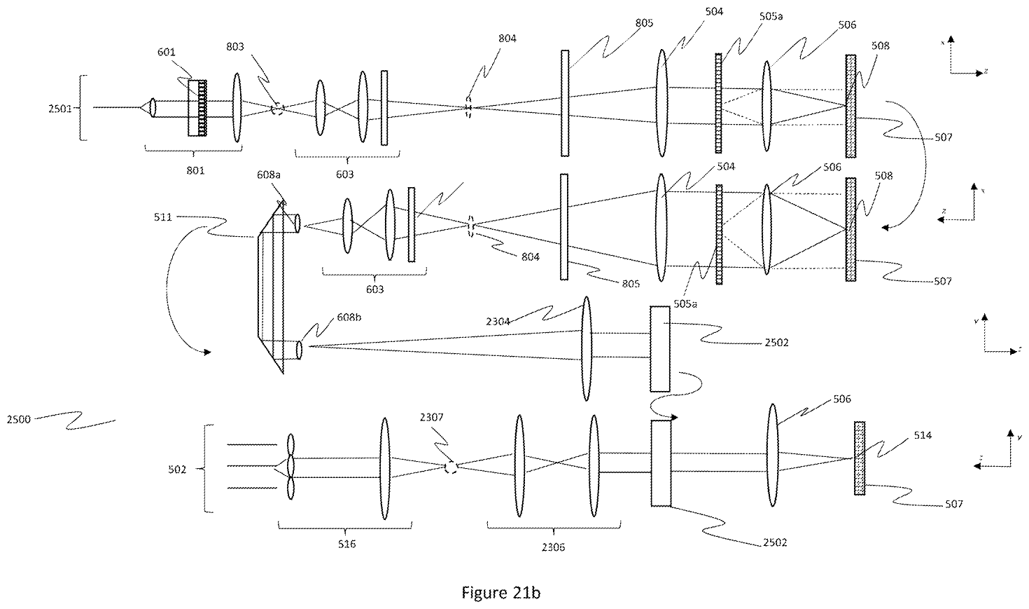

FIGS. 21a and 21b illustrate the detailed optical path of a further exemplary add-drop WSS 2500 which enables both a fan-in and fan-out approach. FIG. 21a illustrates the path in the switching plane, i.e. the y axis shown is the switching axis and the z axis is the optical axis. FIG. 21b illustrates the optical path in the dispersion plane, i.e. the x axis shown is the dispersion axis and the z axis is the optical axis. Thus, FIG. 21b illustrates an orthogonal plane to FIG. 21a. The features of FIGS. 21a and 21b which are the same as those of FIGS. 19a and 19b and operate in the same manner are illustrated with the same reference numerals. The detail of those features is as described above with respect to FIGS. 19a and 19b. The structure and operation of the adWSS of FIGS. 21a and 21b differs from the description of the adWSS of FIGS. 19a and 19b above by the following details.

Firstly, the input ports 2501 of FIGS. 21a and 21b are the same as those of FIGS. 8a and 8b. They are not distributed so as to create a gap in the beams incident on the first programmable deflection plane 508 as with FIGS. 19a and 19b. The light signals propagate from the input ports 2501 to the first programmable deflection plane 508 as described with reference to FIGS. 8a and 8b. The light incident on the first programmable deflection plane is normal to the first programmable deflection plane.

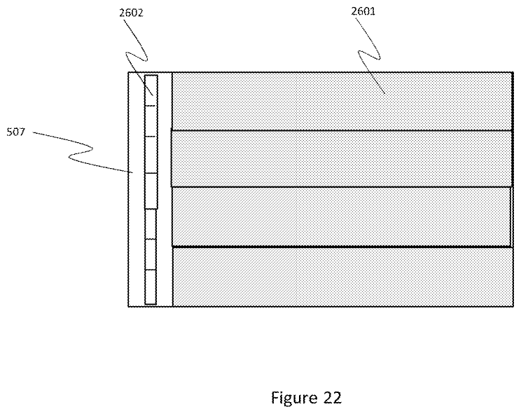

FIG. 22 illustrates the arrangement of spectra and space switches in the case that the switch is an adWSS and both the first and second programmable deflection planes are implemented on a single SLM device. The spectra 2601 are arranged so as to utilise the whole height of the SLM device. There is no unused area of the first programmable deflection plane. Although shown as a landscape arrangement, it will be understood that the SLM device may be arranged in a portrait arrangement or have a non-rectangular shape, as described above.

The first programmable deflection plane 508 applies a programmable deflection to each spectral channel incident on it to form a deflected array of beams. This deflected array of beams propagates through to beam steering optical device 511 as described with respect to FIGS. 19a and 19b.

Again, beam steering optical device 511 is optional in this WSS, but if incorporated operates as described in any of the examples above.

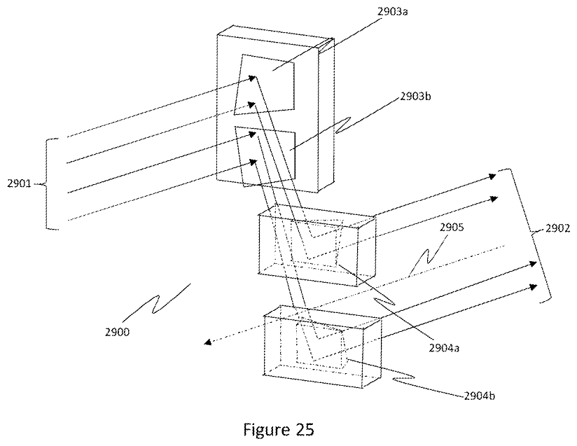

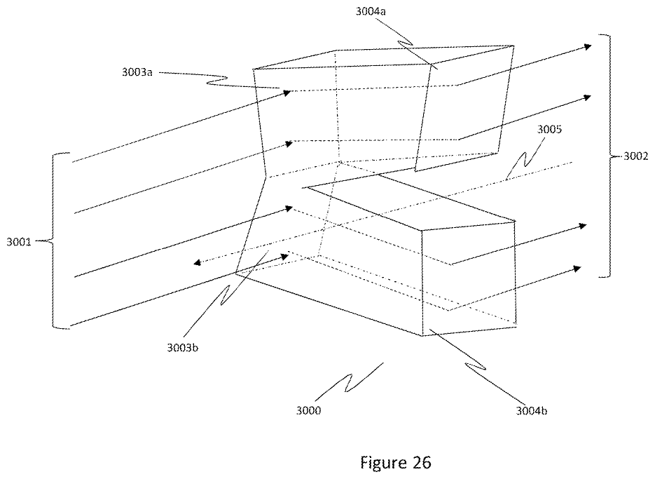

The beams output from the beam steering optical device 511 pass through lens 2304 to optical structure 2502. Optical structure 2502 is located in the optical path between the first and second programmable deflection planes. Optical structure 2502 is located in the optical path between the second programmable deflection plane and the output ports. Optical structure 2502 is located in the focal plane of lens 506. Optical structure 2502 is also located in the focal plane of lens 2304. Optical structure 2502 is located in the conjugate image plane of the first programmable deflection plane. Optical structure 2502 alters the configuration of beams incident on it from the first programmable deflection plane so as to generate a gap between a first set of those beams and a second set of those beams. The optical structure 2502 may comprise a prism or prism assembly or a mirror or mirror assembly. Exemplary optical structures 2502 will be described in more detail with reference to FIGS. 25 and 26 below.

The first and second sets of beams output from the optical structure 2502 are incident on lens 506. Lenses 2304 and 506 are in a 4F arrangement, with optical structure 2502 in the Fourier plane between lenses 2304 and 506. The optical signal incident on the second programmable deflection plane is normal to the second programmable deflection plane.

Referring to FIG. 22, the space switches 2602 are arranged so as to utilise the whole height of the SLM device. There is no gap in the space switches.

The second programmable deflection plane 514 applies a programmable deflection to each of the first and second sets of beams incident on it. The deflection applied by the second programmable deflection plane 514 is so as to direct all the beams incident on it through the gap created by the optical structure 2502. Thus, the deflected first and second sets of beams from the second programmable deflection plane 514 pass through lens 506 and through optical structure 2502 via the gap. From there, the deflected beams are directed towards telescope 2306, and through coupling optics 516 to output ports 502 as described with reference to FIGS. 19a and 19b.

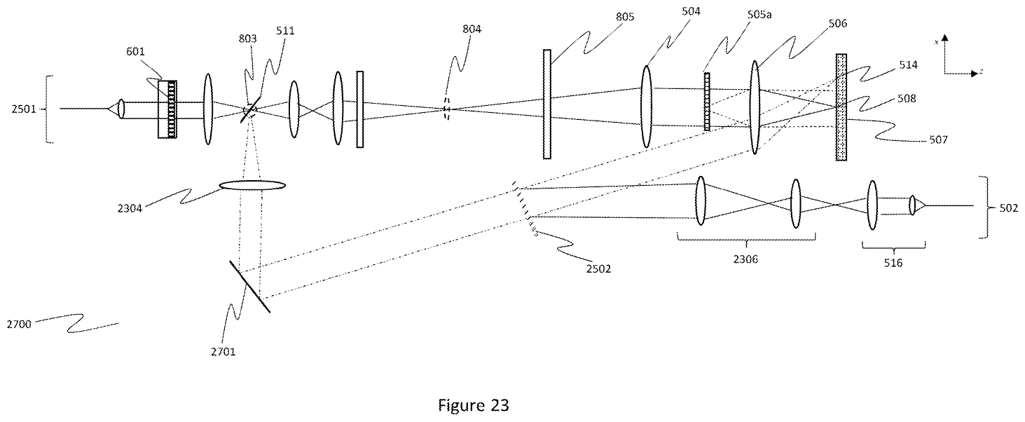

FIG. 23 illustrates an implementation 2700 of the arrangement of FIGS. 21a and 21b in the dispersion plane. The detail of the features of FIG. 23 is as described above with respect to FIGS. 21a and 21b. In the implementation of FIG. 23, a single device comprises both the first and second programmable deflection planes. This single device may, for example, be a SLM device.

Optical signals travel from the input ports 2501 through polarisation conversion system 601 to input circular focus point 803. An anamorphic converter converts the circular beam to an elongated beam which is focussed at input anamorphic focus point. The optical signals then passes through lens 805 and then through lenses 504 and 506 which are in a 4F arrangement. Diffraction grating 505a in the Fourier plane between lenses 504 and 506 disperses the optical signals into spatially separated spectral channels, which are incident on the first programmable deflection plane 508.

The deflected array of beams deflected from the first programmable deflection plane 508 passes back though the same diffraction grating 505a, which this time multiplexes the beams, and lenses 506, 504 and 805 to beam steering optical device 511. Beam steering optical device is positioned above and/or below the input circular focus point 803 in the switching plane. Beam steering optical device 511 directs the remapped array of beams to lens 2304. Lens 2304 converts the remapped array of beams received from the beam steering optical device to parallel light signals, which it directs to the optical structure 2502 in the Fourier plane of lens 2304. A mirror 2701 (which is not shown in FIGS. 21a and 21b) is used in the implementation of FIG. 23 between lens 2304 and optical structure 2502. This mirror 2701 directs the remapped array of beams from the lens 2304 to the optical structure 2502. Suitably, this mirror 2701 is a flat mirror.

The optical structure 2502 generates a gap in the remapped array of beams as described above, and directs the remapped array of beams to the second programmable deflection plane 514 on the single device 507 via the lens 506. The array of beams deflected by the second programmable deflection plane 514 is then routed through the gap in the optical structure 2502 and onto the output ports 502 via the telescope 2306 and coupling optics 516 as described above.

Although FIG. 23 illustrates the beam steering optical device as being positioned above and/or below the input circular focus point 803 in the switching plane, the beam steering optical device could instead be positioned above and/or below the input anamorphic focus point 804 in the switching plane. In this case, an anamorphic telescope is included in the optical path between the second programmable deflection plane and the output ports. For example, the anamorphic telescope may be included between the telescope 2306 and the coupling ports 516. In either the example of FIGS. 21a, 21b and 23 or this further example, a further anamorphic telescope may be positioned between the beam steering optical device 511 and the lens 2304. This further anamorphic telescope is used to enable different aspect ratios of the gaussian focus at the spectra on the first programmable deflection plane 508 and the space switches on the second programmable deflection plane 514.

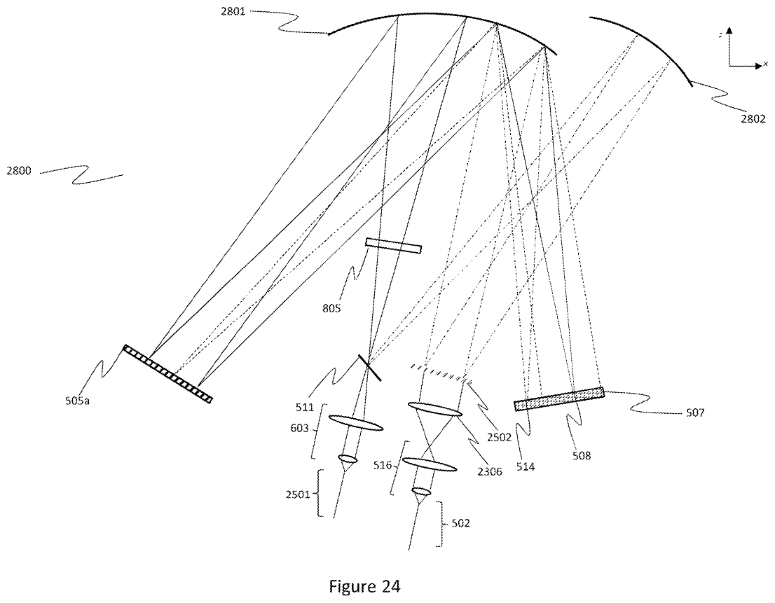

FIG. 24 illustrates an implementation 2800 of the arrangement of FIGS. 21a and 21b in the dispersion plane. The detail of the features of FIG. 24 is as described above with respect to FIGS. 21a and 21b. In the implementation of FIG. 24, a single device comprises both the first and second programmable deflection planes. This single device may, for example, be a SLM device. The implementation 2800 of FIG. 24 utilises two mirrors 2801 and 2802. These mirrors are curved mirrors. Mirror 2801 performs the function of lenses 504 and 506 of FIGS. 21a and 21b. Lens 2802 performs the function of lens 2304 of FIGS. 21a and 21b.

Optical signals travel from the input ports 2501, through anamorphic converter 603 to lens 805. The optical signals are then incident on first mirror 2801, which reflects them to diffraction grating 505a. Diffraction grating 505a is positioned one focal length of the first mirror 2801 from the first mirror 2801. Diffraction grating 505a disperses the optical signals into spatially separated channels, which are then directed back to the first mirror 2801. The first mirror 2801 reflects the dispersed optical signals to the first programmable deflection plane 508 on device 507. The first programmable deflection plane 508 is positioned one focal length of the first mirror 2801 from the first mirror 2801.

The deflected array of beams deflected from the first programmable deflection plane 508 are directed back to the first mirror 2801. The first mirror 2801 reflects the deflected array of beams back to the diffraction grating 505a, which this time multiplexes the beams. From the diffraction grating 505a, the multiplexed beams are directed to the first mirror 2801. The first mirror 2801 reflects the multiplexed beams to the beam steering optical device 511. Beam steering optical device 511 remaps the multiplexed beams to form a remapped array, which it directs to a second mirror 2802.

The second mirror 2802 is positioned one of its focal lengths from the beam steering optical device 511. The second mirror 2802 is positioned one of its focal lengths from the optical structure 2502. The second mirror 2802 reflects the remapped array of beams from the beam steering optical device 511 to the optical structure 2502. The optical structure 2502 generates a gap in the remapped array of beams as described above, and directs the remapped array of beams to the first mirror 2801. The optical structure 2502 is positioned one focal length of the first mirror 2801 from the first mirror 2801. The first mirror 2801 reflects the remapped array of beams to the second programmable deflection plane 514 on the single device 507.

The array of beams deflected by the second programmable deflection plane 514 is directed to the first mirror 2801. The first mirror 2801 reflects the array of beams deflected by the second programmable deflection plane 514 to the gap in the optical structure 2502 and onto the output ports 502 via the telescope 2306 and coupling optics 516 as described above.

The example of FIG. 24 has a minimal number of separate components to perform the described functions of the adWSS.

FIGS. 25 and 26 each illustrates an implementation of the optical structure 2502. In both of these implementations, the optical structure 2505 alters the configuration of the beams incident on it so as to generate a gap between those beams.

The optical structure 2502 of FIG. 25 comprises a prism or mirror array 2900. The prism/mirror array 2900 comprises a first mirror assembly 2903a,2903b and a second mirror assembly 2904a, 2094b. Optical signals 2901 entering the prism/mirror array 2900 are incident on the first mirror assembly 2903a, 2903b. First mirror assembly comprises a first mirror 2903a and a second mirror 2903b. A portion of the optical signals 2901 entering the prism/mirror array 2900 are incident on the first mirror 2903a. A portion of the optical signal 2901 entering the prism/mirror array 2900 are incident on the second mirror 2903b. The first and second mirrors 2903a,2903b are angled away from each other. Thus, when parallel optical signals are incident on the first and second mirrors, the first group of optical signals reflected by the first mirror diverge from the second group of optical signals reflected by the second mirror. A gap thereby forms between the divergent first and second groups of optical signals. These non-parallel divergent first and second groups of optical signals are then routed internally in the prism to the second mirror assembly 2904a,2904b.

Second mirror assembly comprises a third mirror 2904a and a fourth mirror 2904b. The second mirror assembly realigns the first and second groups of divergent optical signals output from the first mirror assembly to be parallel to each other. Third mirror 2904a receives the first group of optical signals reflected from the first mirror 2903a, and reflects this first group of optical signals out of the prism/mirror array. Fourth mirror 2904b receives the second group of optical signals reflected from the second mirror 2903b, and reflects this second group of optical signals out of the prism/mirror array in a direction parallel to the first group of optical signals. The third mirror 2904a and fourth mirror 2904b are inverse to each other. The first and second group of optical signals output from the prism/mirror array 2902 are parallel and separated from each other by a gap. The propagation of light signals 2905 from the second programmable deflection plane to the output ports passes through this gap.

Although the light incident on the prism/mirror array 2901 is shown as parallel to and in the same direction as the light exiting the prism/mirror array 2902, the mirrors of the first and second mirror assemblies may be arranged to direct the light in any direction. For example, the light 2902 may exit the prism/mirror array in an opposing direction to the direction it is input in.

The first and second mirror assemblies are non-overlapping and may be part of a single passive prism element.

FIG. 26 illustrates an optical structure which is a prism 3000 having total internal reflection surfaces which perform the same function as the mirrors of FIG. 25. Thus, parallel incident light beams 3001 on the prism 3000 are redirected within the prism such that the light beams 3002 exiting the prism are in two groups which are parallel but separated by a gap.

The prism comprises a first part having a first total internal reflection (TIR) surface 3003a and a second total internal reflection surface 3004a. The prism also comprises a second part having a third total internal reflection surface 3003b and a fourth total internal reflection surface 3004b. A portion of the optical signals 3001 entering the prism is incident on the first TIR surface 3003a. A portion of the optical signals 3001 entering the prism is incident on the third TIR surface 3003b. The first and third TIR surfaces are angled away from each other. Thus, when parallel optical signals are incident on the first and third TIR surfaces, the first group of optical signals reflected by the first TIR surface 3003a diverge from the second group of optical signals reflected by the third TIR surface 3003b. A gap thereby forms between the divergent first and second groups of optical signals. These non-parallel divergent first and second groups of optical signals are then routed internally in the prism.

The first group of signals reflected by the first TIR surface 3003a is incident on the second TIR surface 3004a. The second TIR surface 3004a reflects this first group of signals out of the prism. The second group of signals reflected by the third TIR surface 3003b is incident on the fourth TIR surface 3004b. The fourth TIR surface 3004b reflects this second group of signals out of the prism. The second and fourth TIR surfaces are angled with respect to each other to realign the first and second groups of divergent optical signals from the first and third TIR surfaces such that they are parallel to each other when output from the prism 3000. The gap between the first and second groups of optical signals caused by their diverging after being reflected by the first and third TIR surfaces is retained when they reflect from the second and fourth TIR surfaces. Thus, the first and second groups of optical signals output from the prism 3002 are separated by a gap. The propagation of light signals 3005 from the second programmable deflection plane to the output ports passes through this gap.

Although the light incident on the prism 3001 is shown as parallel to and in the same direction as the light exiting the prism 3002, the TIR surfaces may be angled and positioned with respect to each other to direct the light in any direction. For example, the light 3002 may exit the prism in an opposing direction to the direction it is input in.

The prism 3000 illustrated in FIG. 26 lies in the image plane of the first programmable deflection plane but wholly external to the gap in the beams projected on that image plane from the first programmable deflection plane. The light signals from the second programmable deflection plane which pass through the gap in the image plane are not incident on the prism 3000 and hence do not propagate through it. Alternatively, the prism 3000 may have a section which is located at the gap in the beams projected on the image plane from the first programmable deflection plane. In this case, that section has no optical power. The section therefore does not obstruct or deflect the light signals from the second programmable deflection plane as they pass through it.

The examples described with reference to FIGS. 19a to 26 enable the beams deflected from the second programmable deflection plane to be directed to the output ports through a gap in the beams projected from the first programmable deflection plane on a conjugate image plane. This allows those beams deflected from the second programmable deflection plane to pass through a single point as they are output, i.e. a fan-out approach. This enables fewer components to be used in the switch overall, and the use of a simplified mirror arrangement such as that shown in FIG. 24. The switch is therefore more compact and simpler and cheaper to manufacture. It also benefits from reduced insertion loss whilst maintaining CDC behaviour.

In the examples described with reference to FIGS. 19a to 26, entrance micro-lenses 608a located in the optical path input to the beam steering optical device, and/or exit micro-lenses 608b located in the optical path output from the beam steering optical device may optionally be used. As in FIGS. 6a and 6b, these micro-lenses aid transmission.

In the examples described with reference to FIGS. 19a to 26, a beam steering optical device 511 is shown in addition to the optical arrangement which enables the fan-out approach to be used. However, the beam steering optical device 511 is not essential to these switches. It is an optional device used to enable the remapping described herein. The beam steering optical device 511 may be omitted from any of the WSSs shown in FIGS. 19a to 26, in which case that WSS has a fan-in and fan-out set up without the remapping described herein.

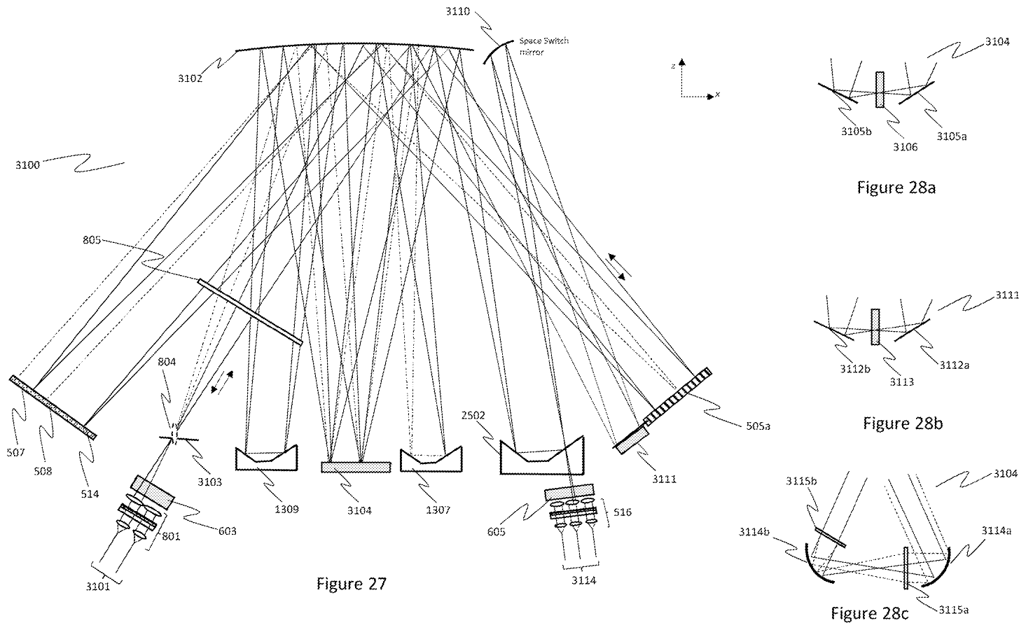

FIG. 27 illustrates an add-drop WSS 3100 in the dispersion plane which incorporates both the remapping described herein and the creation of a gap in the image plane of the first programmable deflection plane described herein. The features of FIG. 27 which are the same as those described above and operate in the same manner are illustrated with the same reference numerals.

Optical signals travel into the WSS via input ports 3101. Input ports 3101 may comprise a non-linear distribution in the dispersion plane. For example, there may be a plurality of columns of ports in the dispersion plane. Alternatively, there may be another non-linear distribution in the dispersion plane such as a hexagonal distribution.

The optical signals travel from the input ports 3101 through coupling optics 801. Coupling optics 801 comprises coupling lenses and polarisation converters, which function as described previously herein. The optical signals travel from the coupling optics 801 to anamorphic telescope 603. Anamorphic telescope 603 causes the optical signals to form a focus at input anamorphic focus point 804. The optical signals are modified by the anamorphic telescope 603 so as to have different widths in the dispersion axis x and switching axis y as described herein.

The optical signals pass from the anamorphic telescope 603 through cylindrical lens 805. Cylindrical lens 805 has power in the switching axis y but no power in the dispersion axis x. Cylindrical lens 805 has a focal length equal to its distance from the input anamorphic focus point 804. The optical signals are collimated by lens 805 and passed to mirror 3102.

The mirror 3102 is curved. The mirror 3102 may be spherically or cylindrically curved (with power in the dispersion axis). Mirror 3102 has a focal length equal to its distance from the input anamorphic focus point 804. The optical signals reflect from mirror 3102 towards diffraction grating 505a. Diffraction grating 505a disperses the optical signals into spatially separated spectral channels, which are then directed back to mirror 3102. The dispersed optical signals are reflected by mirror 3102 towards SLM 507 to produce spectra on the first programmable deflection plane 508 of the SLM 507.

The first programmable deflection plane 508 deflects the dispersed optical signals incident on it in the switching plane. Thus, the first programmable deflection plane 508 adds an angular deviation to the dispersed optical signals in the switching plane. The first programmable deflection plane 508 directs the deflected dispersed optical signals to the mirror 3102. The mirror 3102 directs the deflected dispersed optical signals to the diffraction grating 505a where they are multiplexed by the diffraction grating 505a and directed back to the mirror 3102. The mirror 3102 directs the multiplexed optical signals through lens 805 to flat mirror 3103. Flat mirror 3103 is located in the same position as the input anamorphic focus point 804 in the dispersion plane shown in FIG. 27, but above or below the input anamorphic focus point 804 in the switching plane y. The deviation applied by the first programmable deflection plane 508 shifts the focus position of the optical signals onto the flat mirror 3103.

The flat mirror 3103 reflects the multiplexed optical signals to mirror 3102 through cylindrical lens 805. Mirror 3102 then reflects the multiplexed optical signals to a first composite mirror 3104. First composite mirror 3104 is shown in more detail in FIG. 28a. It comprises two flat mirrors 3105a and 3105b and anamorphic telescope 3106. The flat mirrors 3105a and 3105b may be in a retroreflecting arrangement with the anamorphic telescope 3106 in the optical path between them. The input and output angles of each optical signal to the flat mirrors 3105a and 3105b may differ. The anamorphic telescope 3106 changes the magnification in the dispersion axis x. The anamorphic telescope 3106 controls the relative magnification of the first programmable deflection plane 508 (spectra) and the second programmable deflection plane 514 (space switches), and therefore the overall profile height.

An alternative first composite mirror 3104 is shown in more detail in FIG. 28c. It comprises two curved mirrors 3114a and 3114b with power in the dispersion direction, thereby forming part of an anamorphic telescope. Two further lenses 3115a and 3115b of the anamorphic telescope are positioned relative to the mirrors 3114a and 3114b to achieve the same overall effect as the arrangement of FIG. 28a. Lens 3115a is in the optical path between curved mirrors 3114a and 3114b. Lens 3115b is in the optical path of beams reflected from mirror 3114b.

From the first composite mirror 3104, the optical signals are directed to the mirror 3102. The mirror 3102 then directs the optical signals to a first optical part 1307 of a beam steering optical device. The first optical part 1307 remaps the beams incident on it which are arranged as a plurality of columns to a single column arrangement, as described above with respect to FIG. 13. The first optical part 1307 outputs the remapped single column arrangement of beams to the mirror 3102.

The mirror 3102 directs the remapped single column arrangement of beams to the first composite mirror 3104. The first composite mirror 3104 reflects the remapped single column arrangement of beams back to the mirror 3102. The mirror 3102 then directs the single column arrangement of beams to a second optical part 1309 of the beam steering optical device. The second optical part 1309 remaps the single column arrangement of beams into a remapped distribution. This remapped distribution matches the output port distribution. The second optical part 1309 outputs the remapped optical signals back to mirror 3102.

The mirror 3102 then directs the remapped optical signals to the first composite mirror 3104, which directs the remapped optical signals back to the mirror 3102. The mirror 3102 then directs the remapped optical signals to the optical structure 2502. The optical structure 2502 operates as described above to form a gap in the beams incident on it, and hence a gap in the spectral plane at the location of the optical structure 2502. The optical signals output from the optical structure 2502 propagate to a third mirror 3110. Third mirror 3110 is different to the mirror 3102 and oriented differently to the mirror 3102. Suitably, the third mirror 3110 has the same optical power as the mirror 3102. Third mirror 3110 focusses the optical signals onto a second composite mirror 3111.

The second composite mirror 3111 may be in the plane of the diffraction grating 505a. The second composite mirror 3111 may be adjacent to the diffraction grating 505a. The second composite mirror 3111 may be attached to the diffraction grating 505a. The second composite mirror 3111 is shown in more detail in FIG. 28b. It comprises two flat mirrors 3112a and 3112b and anamorphic telescope 3113. The flat mirrors 3112a and 3112b may be in a retroreflecting arrangement with the anamorphic telescope 3113 in the optical path between them. The input and output angles of the optical signals to the flat mirrors 3112a and 3112b may differ. The anamorphic telescope 3113 changes the magnification in the dispersion axis x. The anamorphic telescope 3113 corrects the distribution to fit on the second programmable deflection plane 514. Alternatively, the second composite mirror 3111 may take the form shown in and described above with respect to FIG. 28c.

From the second composite mirror 3111, the optical signals are directed to the mirror 3102 such that the mirror 3102 reflects the optical signals to form space switches on the second programmable deflection plane 514. The second programmable deflection plane 514 deflects the optical signals back to the mirror 3102. The mirror 3102 then directs the optical signals to the second composite mirror 3111. The second composite mirror 3111 then directs the optical signals to the third mirror 3110. The third mirror 3110 directs the optical signals to the optical structure 2502. The optical signals pass through the gap in the image plane where the optical structure 2502 is positioned to the anamorphic telescope 605. Anamorphic telescope 605 converts the elongated beam to a circular beam for a symmetrical focus for the coupling optics 516. The optical signals are then passed from the anamorphic telescope 605 to the coupling optics 516 where they are coupled to the output ports 3114.

The anamorphic telescopes described herein may have unit magnification in the dispersion plane. The anamorphic telescope 603 and/or 605 may have a non-unitary magnification in the dispersion axis. This enables control of the separation of the ports, which aids fabrication.

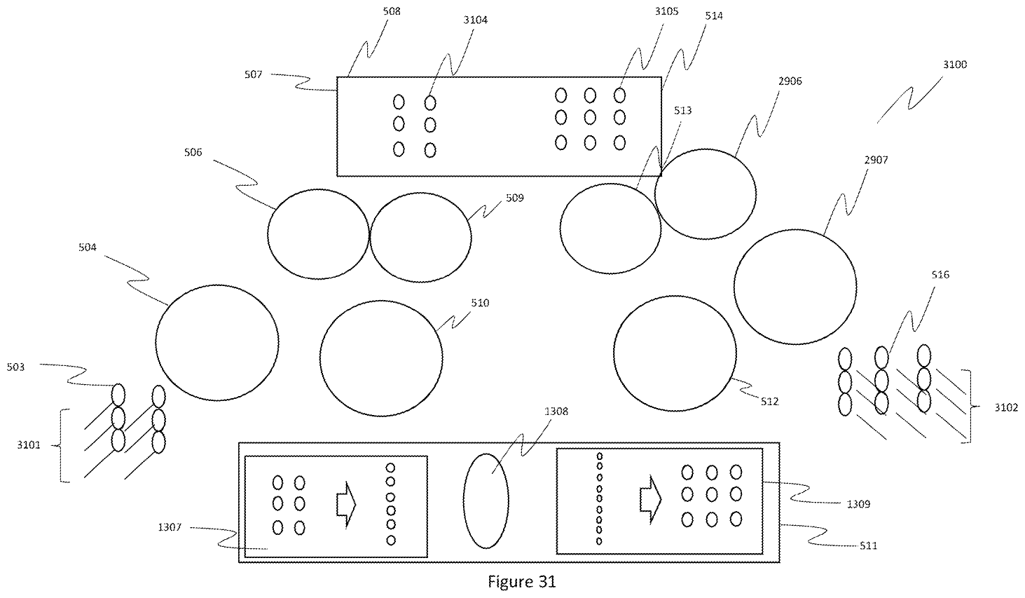

The structure described with reference to FIGS. 31 and 28a and 28b may be used as an add-drop part of an edge ROADM of the type described with reference to FIG. 19.

Many of the examples described herein refer to an adWSS comprising spectra on one programmable deflection plane and space switches on another programmable deflection plane. AdWSSs are less complex and cheaper to manufacture than M×N WSSs, and hence preferred where the output spectrum is coarse and there are a large number of output ports each of which takes only a small number of input channels. However, drop ports can only take channel data from one input port at once. Each of the example adWSS structures described herein could instead be M×N WSSs. In these cases, the beam steering optical device 511 remaps the de-multiplexed spectra incident on it so as to rearrange the geometric arrangement of the channels to match the geometric arrangement of the output ports. The beam steering optical device 511 outputs the remapped de-multiplexed spectra to the second programmable deflection plane. This enables full channel control.

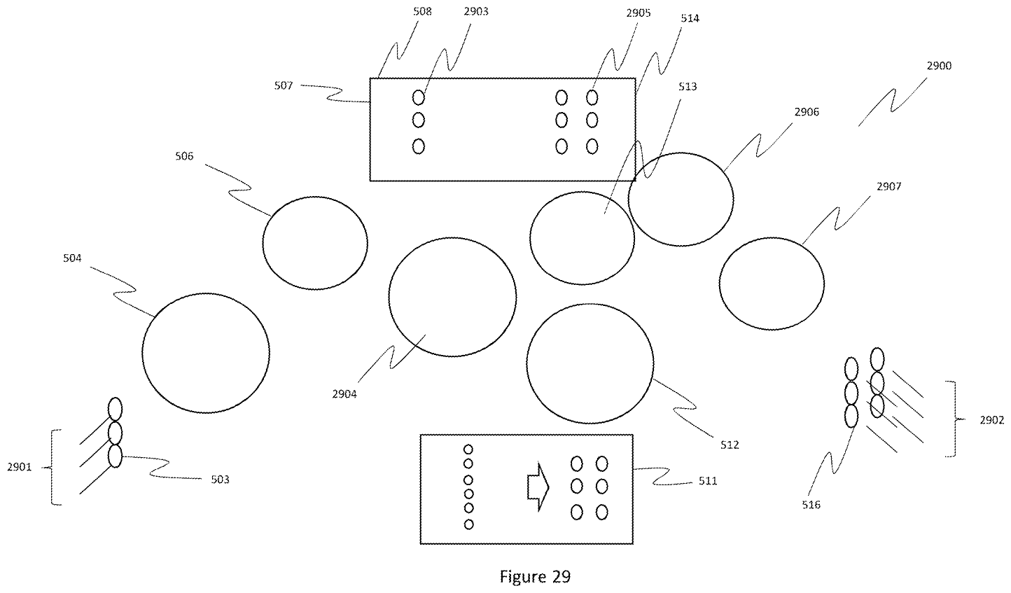

According to other examples, an adWSS may comprise space switches on two programmable deflection planes. FIGS. 29, 30 and 31 illustrate examples of adWSSs in which the arrangement of the input ports is different to that of the output ports and which comprise space switches on two programmable deflection planes. The features of FIGS. 29, 30 and 31 which are the same as those of FIG. 5 and operate in the same manner are illustrated with the same reference numerals. The detail of those features is as described above with respect to FIGS. 5, 6a and 6b.

FIG. 29 illustrates an adWSS 2900 which operates in a similar way to that shown in FIG. 11. The structure and operation of the adWSS of FIG. 29 differs from the description of the adWSS of FIG. 11 by the following details.

In FIG. 29, the input ports 2901 are arranged in a column array and the output ports 2902 are arranged in a grid array. The coupling lenses 503 match the distribution of the input ports 2901. The coupling lenses 516 matches the distribution of the output ports 2902. In contrast to the adWSS of FIG. 11, there is no diffraction grating positioned between lenses 504 and 506. Instead, input beams pass through coupling lenses 503, lens 504 and lens 506 before being incident on the first programmable deflection plane 508. Multiplexed beams are therefore incident on the first programmable deflection plane 508. The array of space switches 2903 on the first programmable deflection plane 508 is in the same conformal shape as the arrangement of the input ports, i.e. a column array in this example. The array of beams from the first programmable deflection plane 508 travels through a lens 2904. Lens 2904 may be a Fourier transform lens. The lens 2904 may form a conjugate plane of the deflected number of beams on the entrance of the beam steering optical device 511. The beam steering optical device 511 remaps the deflected array of beams such that the remapped array of beams directed towards the second programmable deflection plane 514 matches the conformal shape of the output ports 2902. In this case, the shape is a 2×3 rectangular grid. The space switches 2905 on the second programmable deflection plane 514 match the conformal shape of the output ports. The arrangement of the space switches 2905 matches the conformal shape of the remapped array of beams. Thus, the optical device 511 remaps the vertical column of deflected beams input to it to a two-dimensional array of beams for imaging onto the space switches 2905 via the telescopic lenses 512 and 513. The space switches 2905 then deflect the remapped array of beams to the output ports 2902 via lens 2906, lens 2907 and coupling lenses 516. Lenses 2906 and 2907 may form a 4F optical system.

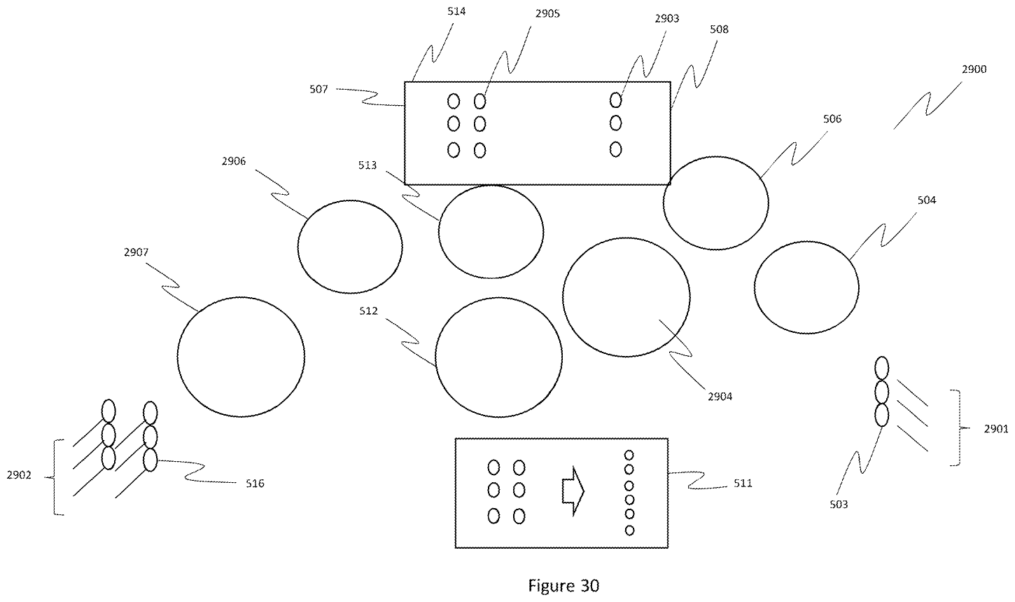

FIG. 30 illustrates the same adWSS 2900 seen in FIG. 29. FIG. 30 shows that the adWSS 2900 can work in reverse. In other words, the adWSS 2900 is fundamentally directionless. FIG. 30 shows that when the adWSS 2900 is operated in reverse, the ports 2902 can be used as input ports and the ports 2901 act as output ports. In other words, input beams are directed from ports 2902 to ports 2901.

From input ports 2902, input beams pass through coupling lenses 516, lens 2907 and lens 2906. Input beams are then incident on the second programmable deflection plane 514. The array of space switches 2905 on the second programmable deflection plane 514 is in the same conformal shape as the arrangement of the input ports, i.e. a 2×3 grid in this example. The array of beams from the second programmable deflection plane 514 travels through lenses 513 and 512 to the beam steering optical device 511. The beam steering optical device 511 remaps the deflected array of beams such that the remapped array of beams directed towards the first programmable deflection plane 508 matches the conformal shape of the output ports 2901. In this case, the shape is a column array. The remapped array of beams pass through lens 2904. Lens 2904 may be a Fourier transform lens. The lens 2904 may form a conjugate plane of the deflected number of beams on the first programmable deflection plane 508. The space switches 2903 on the first programmable deflection plane 508 match the conformal shape of the output ports 2901. The arrangement of the space switches 2905 matches the conformal shape of the remapped array of beams. Thus, the optical device 511 remaps the two-dimensional array of beams input to it to a vertical column of deflected beams onto the space switches 2903. The space switches 2903 then deflect the remapped array of beams to the output ports 2901 via lenses 506 and 504 and coupling ports 503.

FIG. 31 illustrates an adWSS 3100 which operates in a similar way to that shown in FIG. 13. The adWSS 3100 of FIG. 31 also includes elements which are common to the adWSS 2900 seen in FIG. 29. The structure and operation of the adWSS of FIG. 31 differs from the description of the adWSS of FIG. 11 and the adWSS of FIG. 29 by the following details.

In FIG. 31, the input ports 3101 are arranged in a 2×3 grid array and the output ports 3102 are arranged in a 3×3 grid array. The coupling lenses 503 match the distribution of the input ports 3101. The coupling lenses 516 match the distribution of the output ports 3102. In contrast to the adWSS of FIG. 13, there is no diffraction grating positioned between lenses 504 and 506, such that input beams pass through coupling lenses 503, lens 504 and lens 506 before being incident on the first programmable deflection plane 508. Multiplexed beams are therefore incident on the first programmable deflection plane 508. The array of space switches 3104 on the first programmable deflection plane 508 is in the same conformal shape as the arrangement of the input ports, i.e. a 2×3 grid in this example. The array of beams from the first programmable deflection plane 508 travels through lenses 509 and 510 towards the beam steering device. In contrast to the adWSS seen in FIG. 13, there is no diffraction grating positioned between lenses 509 and 510. The multiplexed beams from the first programmable deflection plane 508 are therefore sent to the beam steering device 511 without being multiplexed or demultiplexed. As per the example of FIG. 13, deflected multiplexed light beams are incident on the beam steering device 511. As explained with respect to FIG. 13, optical device 511 comprises optical parts 1307 and 1309 and lens 1308. First, optical part 1307 of optical device 511 converts the double column array of deflected beams from the first programmable deflection plane 508 to a single column array. This single column array is then passed through conjugate Fourier lens 1308 to second optical part 1309. Second optical part 1309 converts the single column array to a three column array matching the array of space switches 3105 on the second programmable deflection plane 514. This three column array is then imaged by telescopic lenses 512 and 513 to the space switches 3105 on second programmable deflection plane 514. The space switches 3105 deflect the remapped array of beams to the output ports 3102 via lens 2906, lens 2907 and coupling lenses 516. Lenses 2906 and 2907 may form a 4F optical system.

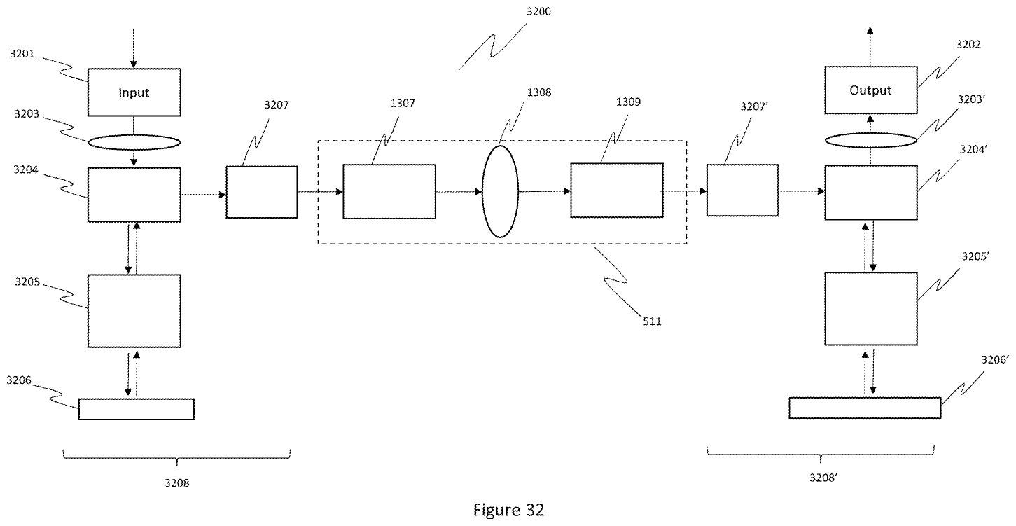

FIG. 32 illustrates a further example of a M×N WSS 3200. Input light beams from N input ports 3201 pass through a first optical structure 3208 before reaching a beam steering device 511. When the beams leave the beam steering device 511, they pass through a second optical structure 3208′ before reaching output ports 3202. The second optical structure 3208′ may be identical to the first optical structure 3208, for example when M=N. In other examples, the first and second optical structures 3208, 3208′ may not be identical.

The first optical structure 3208 comprises a fan lens 3203, a flat mirror 3204, an optical system 3205, a first programmable deflection plane 3206 and a 4F optical system 3207. The second optical structure comprises a fan lens 3203′, a flat mirror 3204′, an optical system 3205′, a second programmable deflection plane 3206′ and a 4F optical system 3207′.

From input ports 3201, the input light beams pass through the fan lens 3203 which focusses the light through an aperture in the flat mirror 3204. The flat mirror is a mirror optic which may be referred to as a split aperture mirror (SAM). The input light beams then pass through the optical system 3205 towards the first programmable deflection plane 3206. The optical system 3205 may comprise a 4F optical system. The optical system 3205 images the optical signal in the dispersion plane, for example using two 4F dispersion lenses. The optical system may additionally form a Fourier conjugate in a direction normal to the beam path, along the steering axis. For example, the optical system 3205 may further include a lens in the steering plane located between two 4F dispersion lenses. The lens may be a Fourier lens.

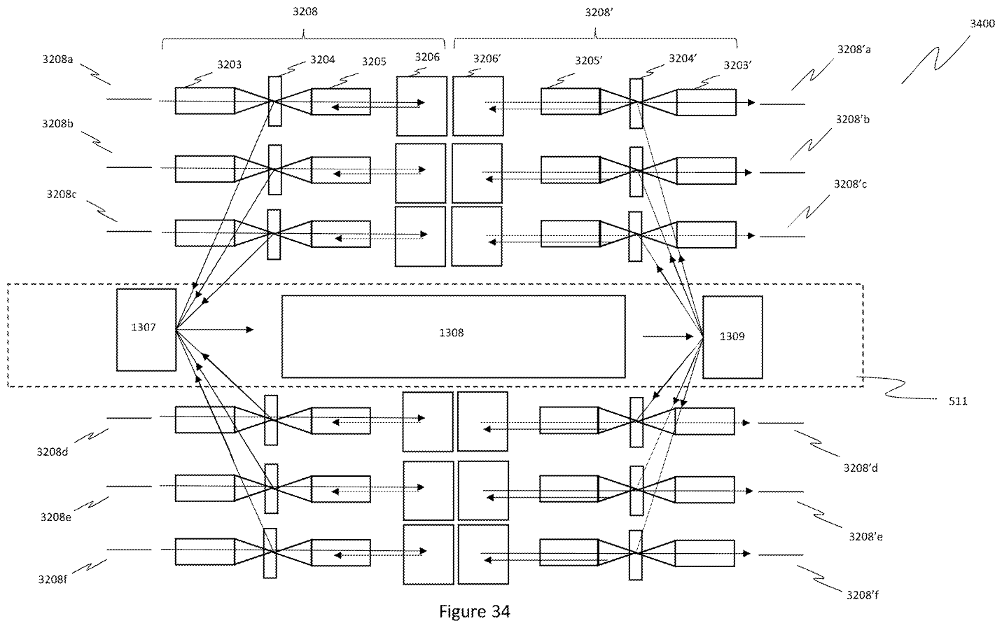

The light is imaged in both directions onto the first programmable deflection plane 3206. Deflected light is then passed back through the optical system 3205 into the SAM 3204. As seen in FIG. 34, when the light passes back through the SAM, it is deflected by the SAM in a direction away from the input ports 3201. The deflected light then passes through 4F optical system 3207 and is incident on the beam steering device 511 of the type seen in FIGS. 13 and 31. The beam steering device 511 comprises optical parts 1307 and 1309 and lens 1308. The lens 1308 may be a conjugate Fourier lens.

From the beam steering device 511, the light is passed in through the second optical structure 3208′ which may be identical to the first optical structure 3208, towards the output ports 3202. In other words, the light beams pass through the 4F optical system 3207′, the SAM 3204′ and the optical system 3205′ before being deflected by the second programmable deflection plane 3206′ back through the optical system 3205′, SAM 3207′ and lens 3203′ towards the output ports 3202. The arrangement shown in FIG. 32 has the advantage that the input ports 3201 and the output ports 3202 may be separated laterally by a small distance. Despite the small distance between the input and output ports, the described arrangement reduces crosstalk between the two sets of ports. The input ports 3201 and output ports 3202 may be positioned parallel to one another as seen in FIG. 32.

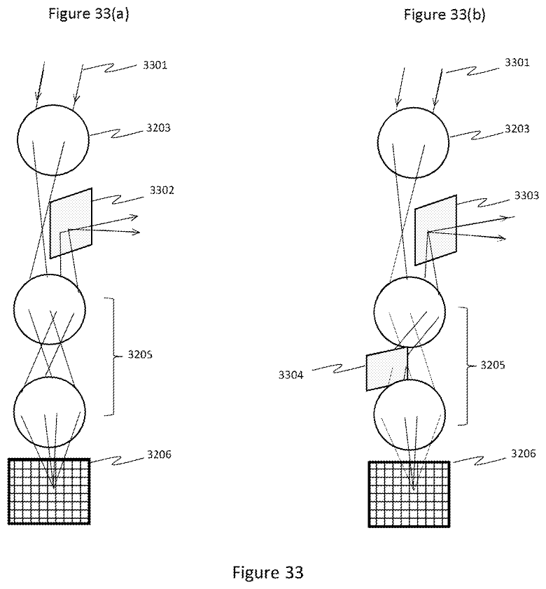

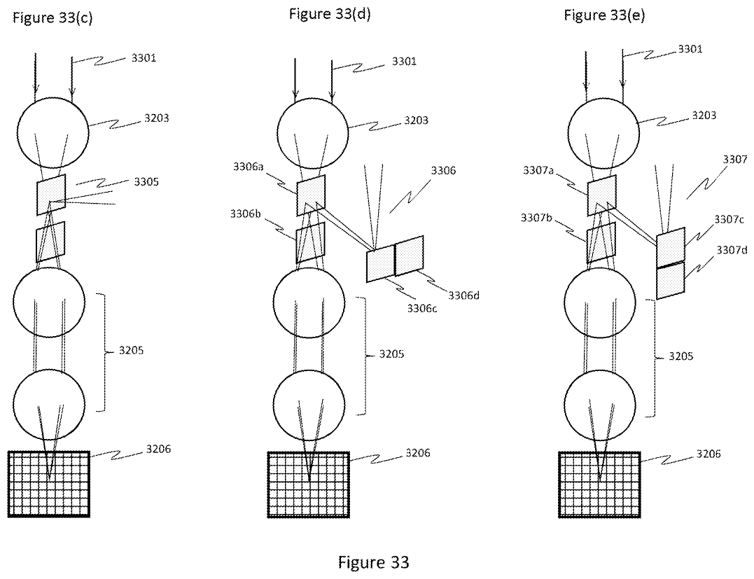

The mirror optics (SAMs) 3204 and 3204′ seen in FIG. 32 may take a variety of forms, as illustrated in FIGS. 33(a) to (e). In other words, there are a number of different types of SAM which could be used in the switch 3200. FIG. 33 illustrates five possible types of SAM (3302, 3303, 3305, 3306, 3307) but other types may exist.

Each FIG. 33(a) to (e) illustrates an optical structure to which light 3301 is input. In FIGS. 33(a) and 33(b), the input light is not parallel to the steering axis. The input light may be known as “off-axis” light. In FIGS. 33(c) to (e), the input light is parallel to the steering axis. This may be known as “on-axis” light. The structure to which the light in each case is input includes a fan lens 3203, an optical system 3205 and a programmable deflection plane 3206, as previously described with respect to FIG. 32. As previously described, the optical system 3205 may comprise a set of two 4F lenses configured to image the signal in the dispersion plane and a lens configured to form a Fourier conjugate in the steering direction. FIGS. 33 illustrate only the set of 4F dispersion lenses. Any components of the optical system 3205 in the steering plane are not shown.

In FIG. 33(a), the SAM 3302 takes the form of an edge of a mirror located near the input light beam. This type of SAM may be referred to as a “knife edge”. FIG. 33(a) shows that due to the direction of the input light and position of the mirror 3302, the input light passes by the edge of the mirror. In other words, the input light is not deflected by the SAM 3302. Once the light has been deflected by the programmable deflection plane 3206 and has passed back through optical system 3206, the deflected light is intercepted by the mirror 3302 and deflected such that the light is directed away from the input light. As illustrated in FIG. 33(a), the deflected light is not intercepted by the mirror 3302 at its focus. Instead, the mirror intercepts the light ahead of its focus.

FIG. 33(b) illustrates the same arrangement as that seen in FIG. 33(a) with the addition of a deflection optic 3304 located between the two 4F dispersion lenses in the optical system 3205. The dispersion optic changes the angle of the deflected light in the Fourier plane between the two 4F lenses so as to create a positional change in the light. The result of this positional change is that the mirror 3303 intercepts the deflected light at its focus, as shown in FIG. 33(b).

In FIG. 33(c), the SAM 3305 is a traditional split aperture mirror. The SAM 3305 comprises two mirrors separated by a gap. In the example shown, the two mirrors are displaced from one another in the steering direction. FIG. 33(c) shows that the input light is focused by the fan lens 3203 so that it passes through the gap between the two mirrors. In other words, the input light passes by the SAM 3305 without being deflected. Once the light has been deflected by the programmable deflection plane 3206 and has passed back through optical system 3205, the deflected light is intercepted by one of the two mirrors of the SAM 3305 at its focus. As mentioned above, the optical system 3205 includes a steering lens (not shown), which may be positioned between the two 4F dispersion lenses. The steering lens forms a Fourier conjugate focus in the steering direction at the SAM mirror plane such that the light is intercepted by one of the two mirrors of the SAM 3305. In other words, the steering lens of the optical system 3205 deflects the light deflected by the programmable deflection plane 3206 in the steering direction so that instead of passing through the gap between the two mirrors, the light is incident on one of the two mirrors forming the SAM 3305. The light is then deflected by the intercepting mirror such that the light is directed away from the input light.

In FIG. 33(d), the SAM 3306 is a device which remaps the beams incident on it to new locations. The SAM 3306 may be the beam steering device 511 previously described. The SAM 3306 comprises a mirror array and has a form similar to the example beam steering device seen in FIG. 16. The example SAM 3306 seen in FIG. 33(d) comprises a first set of two mirrors 3306a, 3306b separated by a gap and a second set of mirrors 3306c, 3306d spaced apart from the first set of mirrors, the second set of mirrors being positioned side-by-side without a gap between them. In this example, the first set of two mirrors 3306a, 3306b are displaced from one another in the steering direction, with a gap between them along the steering axis. The second set of mirrors 3306a, 3306b are displaced from one another in the dispersion direction, without a gap between them along the dispersion axis. As previously explained with respect to FIG. 16, each group of points incident on the device reflects off a pair of mirror surfaces and follows a different optical path through the mirror array. According to further examples, the mirror array of the SAM 3306 may have a different configuration to that shown in FIG. 33(d).

FIG. 33(d) shows that input light is focused by the fan lens 3203 so that it passes through the gap between the two mirrors of the first set of mirrors 3306a, 3306b. In other words, the input light passes by the SAM 3306 without being deflected. Once the light has been deflected by the programmable deflection plane 3206 and has passed back through optical system 3205, the deflected light is intercepted by one of mirrors 3306a, 3306b of the SAM 3306. The light is reflected by one of the mirrors 3306a, 3306b onto one of mirrors 3306c, 3306d. FIG. 33(d) shows a group of points which are reflected from mirror 3306a onto mirror 3306c, but other groups of points may take other paths through the device. The reflected light is further reflected by mirror 3306c. The light is thus deflected by the SAM 3306 such that it is directed away from the input light.

In FIG. 33(e), the SAM 3307 is a device which alters the configuration of beams incident on it so as to generate a gap between a first set of those beams and a second set of those beams. The SAM 3307 may be the optical structure 2502 previously described. The SAM 3307 comprises a mirror array and has a form similar to the example optical structure seen in FIG. 25. The example SAM 3307 seen in FIG. 33(e) comprises a first set of two mirrors 3307a, 3307b separated by a gap and a second set of mirrors 3307c, 3307d spaced apart from the first set of mirrors, the second set of mirrors being positioned without a gap between them. In this example, the first set of two mirrors 3307a, 3307b are displaced from one another in the steering direction, with a gap between them along the steering axis. The second set of mirrors 3307a, 3307b are displaced from one another in the steering direction, without a gap between them along the steering axis. As previously explained with respect to FIG. 25, a portion of optical signals incident on the device are incident on the mirror 3307a and a portion is incident on the mirror 3307b.

FIG. 33(e) shows that input light is focused by the fan lens 3203 so that it passes through the gap between mirrors 3307a and 3307b. In other words, the input light passes by the SAM 3307 without being deflected. Once the light has been deflected by the programmable deflection plane 3204 and has passed back through optical system 3205, the deflected light is intercepted by one of mirrors 3307a, 3307b of the SAM 3307. The light is reflected by one of the mirrors 3307a, 3307b onto one of mirrors 3307c, 3307d. FIG. 33(e) shows a portion of the light which is reflected from mirror 3307a onto mirror 3307c. Other portions of light will be reflected from mirror 3307b to mirror 3307d. The reflected light is further reflected by mirror 3307c. The light is thus deflected by the SAM 3307 such that it is directed away from the input light and such that the light is split into two separate sets of beams.

FIG. 34 illustrates an arrangement 3400 of multiple of the WSSs 3200 seen in FIG. 32. In the arrangement 3400 there are K first optical structures 3208. In the example seen in FIG. 34, K=6 (i.e. the arrangement includes first optical structures 3208(a) to (f)). The arrangement 3400 further includes P second optical structures 3208′. In the example seen in FIG. 34, P=6 (i.e. the arrangement includes second optical structures 3208′(a) to (f)). In the example seen in FIG. 34, the arrangement includes the same number of first optical structures 3208 as second optical structures 3208′ i.e. K=P. The illustrated arrangement is therefore symmetrical. According to other examples, the arrangement may not be symmetrical such that K≠P.

The first and second optical structures 3208, 3208′ take the forms previously described with respect to FIGS. 32 and 33. Each first optical structure 3208 therefore includes a first programmable deflection plane 3206, which may be known as an input plane. Each second optical structure 3208′ includes a second programmable deflection plane 3206′, which may be known as an output plane. Each first optical structure 3208 includes a SAM 3204. Each second optical structure includes a SAM 3204′.

Each of the first optical structures 3208(a) to (f) includes a set of L input ports. The arrangement 3400 thus includes K sets of L input ports. The total number of input ports present in the arrangement 3400 is therefore equal to K×L. Each of the second optical structures 3208′(a) to (f) includes set of Q output ports. The arrangement 3400 thus includes P sets of Q output ports. The total number of output ports present in the arrangement 3400 is therefore equal to P×Q. In the arrangement 3400, each pair of optical structures 3208, 3208′ comprises the same number of input ports as output ports i.e. L=Q. In other words, the structure is symmetrical. In other examples, the structure may not be symmetrical. For a pair of optical structures 3208, 3208′, the number of input ports L may be different to the number of output ports L≠Q.

As illustrated, the first and second optical structures 3208 and 3208′ respectively direct light to and from a common beam steering device 511. In other words, light from each of N input ports is channelled through the same beam steering device 511. The beam steering device 511 takes the same form as that seen in FIG. 32. As previously described and as illustrated in FIG. 34, for each of the first optical structures 3208(a) to (f), deflected light deflected by the SAM 3204 in the first optical structure 3208 is directed to the beam steering device 511 and is incident on the first optical part 1307 of the beam steering device 511 at L ports (where L is the number of input ports associated with each first optical structure 3208). Thus, in the whole arrangement 3400 of FIG. 34, light from the K sets of L input ports is directed to N ports on the first optical part 1307 of the beam steering device 511, where N=K×L. The array of L input ports at each input position (i.e. on each of the K first programmable deflection planes 3206) can be in an arbitrary distribution or array shape and is transposed to a column of N ports by the first optical part 1307.

As the N ports pass through the lens 1308, as previously described, the column of N ports is mapped onto a column of M ports. At the second optical part 1309, the column of M ports is transposed to a grid of M ports having a different distribution. As previously described, the arrangement 3400 includes P second optical structures 3208′ and each of the second optical structures 3208′(a) to (f) includes set of Q output ports. The arrangement 3400 thus includes P sets of Q output ports. The total number of output ports present in the arrangement 3400 is therefore equal to P×Q. The grid of M ports are distributed back to the P sets of Q output ports through the second optical structures 3208′(a) to (f). It is therefore the case that M=P×Q.

In this example, the first programmable deflection planes (3206) and the second programmable deflection planes (3206′) are arrayed interleaved with one another. As previously described, the first and second programmable deflection planes may be incorporated onto a single SLM device or may be located on separate SLM devices. The advantage of the arrangement 3400 is that a large number of separate SLMs can be used to create a much larger switch port number N and/or M that would be obtainable from a single SLM, while still utilising only 1D SLM steering. In other words, the number of programmable deflection planes required for a given number of N input ports is reduced such that for a given number of programmable deflection planes (for example a given number of SLM devices), a larger number of N input ports (and/or M output ports) can be used.

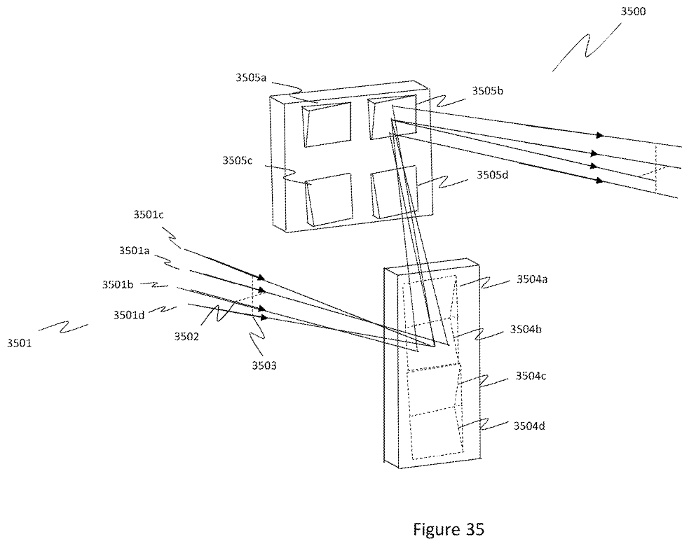

FIG. 35 illustrates a further implementation of the beam steering device 511. Similar to the beam steering optical device seen in FIG. 16, the device shown in FIG. 35 comprises a mirror array 3500. As with the example seen in FIG. 16, the mirror array 3500 remaps an array of points 3501 incident on it to a grid of points 3504 having a different conformal pattern, as previously described. The beam steering device 511 of FIG. 35 is designed so as to utilise incoming astigmatic light to optimise transmission through the beam steering device. As explained in more detail below, the beam steering device comprises pairs of parallel mirror surfaces.

FIG. 35 illustrates that the mirror array 3500 includes a first set of four mirror surfaces 3504a, 3504b, 3504c, 3504d arranged in a column. The mirror array further includes a second set of four mirror surfaces 3605a, 3605b, 3605c, 3605d arranged in a 2×2 grid. The mirror array 3500 remaps a single column of points incident on it to a grid of points. The mirror array 3500 splits the column points into groups. Each group of points follows a different optical path through the mirror array 3500. FIG. 35 illustrates just one group 3501 however it will be understood that more groups may be used. Each group of points reflects off a pair of mirror surfaces, the pair of mirror surfaces being parallel to one another.

The group 3501 includes light to which an astigmatism has been applied For example, in the M×N WSS 3200 seen in FIG. 32, an astigmatism may be applied to the input light by the optical elements positioned between the first programmable deflection plane 3206 and the beam steering device 511, for example by altering the position and focal length of the steering lenses with respect to the dispersion lenses in the optical system 3205. Astigmatic light features a difference in focus position along the optical axis for two orthogonal planes. In the example seen in FIG. 35, these are the orthogonal steering and dispersion planes. As seen in FIG. 35, the astigmatic light beam 3501 is divided into a portion of light aligned with the dispersion direction 3502 (the dispersion plane) and a portion of light aligned with the steering direction 3503 (the steering plane). In FIG. 35, the dispersion plane is illustrated by only a pair of lines 3501a and 3501b for illustrative purposes. In FIG. 35, the steering plane is illustrated by only a pair of lines 3501c and 3501d for illustrative purposes.

As seen in FIG. 35, the input light beam 3501 is incident on first mirror surface 3504b and second mirror surface 3505b. Normally, astigmatic light is undesirable but as explained below, in the following example, astigmatic light is used to optimise transmission and minimise losses through the mirror array. It is not necessary in the beam steering device for both the steering plane and the dispersion plane of the incoming astigmatic light 3501 to be focused by a single mirror surface. It is however important that when the light beam is incident on the vertical column of mirror surfaces 3504a-d, that the beam is in focus along the steering axis such that the beam is incident on only one of mirrors 3504a-d. It is not important at this stage whether or not the beam is focused along the dispersion axis. In contrast, when the light beam is incident on the 2×2 grid of mirror surfaces 3505a-d which includes mirrors spaced along the dispersion axis, it is important that the beam is in focus in the dispersion direction. As shown in FIG. 35, the steering plane 3501c, 3501d is focused on first mirror surface 3504b. The dispersion plane 3501a, 3501b is focused on the second mirror surface 3505b.

In contrast to the beam steering device seen in FIG. 16 in which each mirror surface of a pair of mirror surfaces are angled with respect to each other, in the example seen in FIG. 35, each mirror surface in a pair is parallel is with respect to the other mirror surface in the pair. Specifically, in this example, mirror surface 3504a is parallel to mirror surface 3505a, mirror surface 3504b is parallel to mirror surface 3505b, mirror surface 3504c is parallel to mirror surface 3505c and mirror surface 3505d is parallel to mirror surface 3505d.

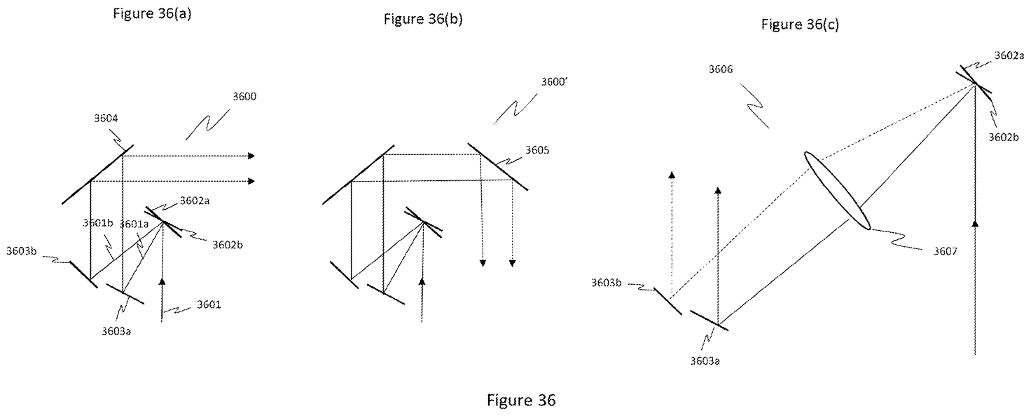

When incoming light is reflected sequentially by two mirror surfaces which are not parallel, the light input to the beam steering device (and therefore its associated optical image) is rotated about the optical axis. In other words, the direction of light entering the beam steering device is not the same direction as the light leaving the device. Such rotation can be accounted for by optical components later in the path taken by the incoming light, but it is generally preferable to eliminate any rotation of the optical image input to the device. The beam steering devices seen in FIGS. 35 and 36 therefore incorporate pairs of parallel mirror surfaces into the first and second planes of mirror surfaces. The result of incoming light being incident on pairs of parallel mirror surfaces is that the direction of light entering the beam steering device is the same direction as the light leaving the device and no rotation of the optical image about the optical axis occurs. There is therefore no need for additional optical components in the system to later correct for such rotation. An analogous approach can be taken with regards to the optical structures described herein configured to alter the configuration of incident beams so as to generate a gap between those beams.

It is undesirable to input astigmatic light to the second programmable deflection plane or the output ports. The beam steering device 511 seen in FIG. 35 may therefore be used as part of a switch having an optical system configured to correct out the astigmatism. For example, in the M×N WSS 3200 seen in FIG. 32, an optical system configured to correct out the astigmatism may be positioned between the beam steering device 511 and the second programmable deflection plane 3206′. Any of the previously described anamorphic telescopes may be modified so as to correct for the astigmatism in addition to making the input light beam more circular, as described. In the same way as the astigmatism is applied to the light by the optical system 3205, the position and focal length of the steering lenses with respect to the dispersion lenses in the optical system 3205′ may be adjusted so as to remove the astigmatism after the light has passed through the mirror array 3500.

FIGS. 36(a), 36(b) and 36(c) illustrate three possible configurations for the mirror surfaces in the beam steering device 511 of the type seen in FIG. 35 comprising pairs of parallel mirror surfaces. FIGS. 36(a)-(c) show examples of mirror arrays in beam steering devices having a view into the dispersion plane (i.e. along the steering axis).

FIG. 36(a) illustrates a beam steering device 3600 in which a first plane of mirror surfaces 3602a, 3602b are in the form of a column (i.e. they are displaced along the steering axis). A second plane of mirror surfaces 3603a, 3603b are laterally spaced i.e. displaced in the dispersion direction. FIG. 36(a) shows two mirror surfaces in each set of mirror surfaces. It will be understood that each set of mirror surfaces may include more than 2 mirror surfaces, for example 4 mirror surfaces as shown in FIG. 35. As seen in FIG. 36(a), the light (3601a) which is incident on mirror surface 3602a is reflected onto and then reflected by mirror surface 3603a. The light (3601b) which is incident on mirror surface 3602b is reflected onto and then reflected by mirror surface 3603b. Mirror surfaces 3602a and 3603a are parallel to one another. The light incident on the first plane of mirror surfaces 3602a, 3602b is therefore parallel to light leaving the second plane of mirror surfaces 3603a, 3603b. As previously explained with respect to other beam steering devices, it is important that that other conditions are observed, such as the fact that the path length through the mirror array should be the same for all beam paths so that a coincident focus can be achieved for all beams.

The mirror array of FIG. 36(a) further includes a flat directing mirror 3604. In the example seen in FIG. 36(a), the mirror is used to change the direction of light leaving the second plane of mirror surfaces by 90 degrees. The angle between the light 3301 entering the beam steering device 3600 and the light leaving the device is therefore 90 degrees. The plane of the mirror 1604 is normal to the dispersion plane. To avoid rotation of the optical signal as previously discussed, the mirror 3604 may be rotated relative to mirror surfaces 3602, 3603 about any axis normal to the optical axis direction.

FIG. 36(b) illustrates a further beam steering device 3600′ which includes all the features described as being part of the device 3600. In addition, the mirror array includes a further flat directing mirror 3605. The angle between the light 3601 entering the beam steering device 3600′ and the light leaving the device is therefore 180 degrees. FIG. 36(b) therefore illustrates that multiple flat directing mirrors can be used to direct the beam leaving the second plane of mirror surfaces. The flat directing mirrors 3604, 3605 do not cause a rotation of light incident on them about the optical axis as they are positioned such that the plane of each of the mirrors is normal to the optical axis (and the dispersion axis). Other beam steering devices may include a different number of flat directing mirrors. As previously described, any of the mirror surfaces described may be replaced with any reflecting surface, for example a prism exhibiting total internal reflection, multilayer interference surfaces or polarisation-dependent beam-splitting elements.

FIG. 36(c) illustrates a further beam steering device 3606 featuring the same first plane of mirror surfaces 3602a, 3320b and second plane of mirror surfaces 3603a, 3603b. An optical system 3607 is positioned between the first and second planes of mirror surfaces. FIG. 36(c) illustrates an example in which the optical system 3607 is a cylindrical Fourier lens aligned with the dispersion axis. According to other examples, the optical system 3607 may comprise one or more mirrors, diffractive and/or holographic elements. The optical system 3607 may comprise a sequence of normal and/or freeform lenses. According to further examples, multiple lenses may be positioned between the two planes of mirror surfaces 3602, 3603. For example, a 4F optical system may be positioned between the first and second planes of mirror surfaces. The optical system 3607 may comprise any element with optical power. The optical system is used to image the light leaving the first plane of mirror surfaces onto the second plane of mirror surfaces. In general, the optical system 3607 may be any known imaging system which would enable the beam steering device 3606 to remap the incoming array of beams 3601 as previously described.

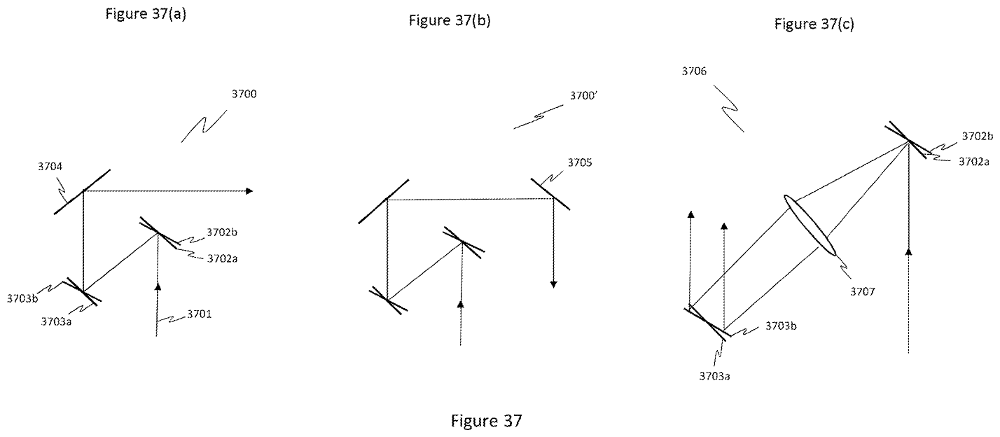

For the same reasons, it can be advantageous to use pairs of parallel mirror surfaces in optical structures such as those shown in FIG. 25. FIGS. 37(a), 37(b) and 37(c) illustrate further examples of optical structures configured to alter the configuration of the beams incident on it so as to generate a gap between those beams, the structures comprising pairs of parallel mirrors.

FIG. 37(a) illustrates an optical structure 3700 comprising a mirror array which comprises a first mirror assembly 3702 and a second mirror assembly 3703. As per the optical structure illustrated in FIG. 25, each mirror assembly comprises two mirror surfaces. The first mirror assembly 3702 comprises a first mirror surface 3702a and a second mirror surface 3702b. The second mirror assembly 3703 comprises a third mirror surface 3703a and a fourth mirror surface 3703b. The first mirror surface 3702a and the second mirror surface 3702b are displaced relative to one another along the steering axis. The third mirror surface 3703a and the second mirror surface 3703b are displaced relative to one another along the steering axis. The viewpoint of FIG. 37 is into the dispersion plane (i.e. along the steering axis).

As previously described with respect to FIG. 25, optical signals 3701 entering the mirror array are incident on the first mirror assembly 3702. A portion of the optical signals entering the mirror array are incident on the first mirror surface 3702a. A portion of the optical signal 3701 entering the mirror array are incident on the second mirror surface 3702b. The first and second mirror surfaces are angled away from each other. Thus, when parallel optical signals are incident on the first and second mirror surfaces, the first group of optical signals reflected by the first mirror surface diverge from the second group of optical signals reflected by the second mirror surface. A gap thereby forms between the divergent first and second groups of optical signals. These non-parallel divergent first and second groups of optical signals are then routed to the second mirror assembly 3703. The light reflected by the first mirror surface 3702a (the first group of optical signals) is directed to the third mirror surface 3703a of the second mirror assembly 3703. The light reflected by the second mirror surface 3702b (the second group of optical signals) is directed to the fourth mirror surface 3703a of the second mirror assembly 3703. Third mirror surface 3703a reflects this first group of optical signals out of the mirror array. Fourth mirror 3703b reflects this second group of optical signals out of the mirror array in a direction parallel to the first group of optical signals. The third mirror 3703a and fourth mirror 3703b are inverse to each other. The first and second group of optical signals output from the mirror array 3700 are parallel and separated from each other by a gap. Mirror surfaces 3702a and 3703a are parallel to one another. The portion of the optical signals incident on the first mirror surface 3702a is therefore parallel to the portion of the optical signal leaving the third mirror surface 3703a. Mirror surfaces 3702b and 3703b are parallel to one another. The portion of the optical signals incident on the first mirror surface 3702b is therefore parallel to the portion of the optical signal leaving the third mirror surface 3703b. As previously described, any rotation of the optical image input to the mirror array is therefore eliminated. The mirror array of FIG. 37(a) further includes a flat directing mirror 3704, which takes the same form as mirror 3604 described with respect to FIG. 36(a).

FIG. 37(b) illustrates a further optical device 3700′ which includes all the features described as being part of the device 3700. In addition, the device includes a further flat directing mirror 3705. The angle between the light 3701 entering the optical device 3700′ and the light leaving the device is therefore 180 degrees. FIG. 37(b) therefore illustrates that multiple flat directing mirrors can be used to direct the beam leaving the second array of mirror surfaces 3703. The flat directing mirrors 3704, 3705 do not cause a rotation of light incident on them about the optical axis as they are positioned such that the plane of each of the mirrors is normal to the optical axis. Other beam steering devices may include a different number of flat directing mirrors. As previously described, any of the mirror surfaces described may be replaced with any reflecting surface, for example a prism exhibiting total internal reflection, multilayer interference surfaces or polarisation-dependent beam-splitting elements.

FIG. 37(c) illustrates a further optical device 3706 featuring the same first array of mirror surfaces 3702 second array of mirror surfaces 3703. An optical system 3707 is positioned between the first and second planes of mirror surfaces. The optical system 3707 may comprise one or more mirrors, diffractive and/or holographic elements. The optical system 3707 may comprise a sequence of normal and/or freeform lenses. According to further examples, multiple lenses may be positioned between the two planes of mirror surfaces 3702, 3703. For example, a 4F optical system may be positioned between the first and second planes of mirror surfaces. The optical system 3707 may comprise any element with optical power. The optical system is used to image the light leaving the first plane of mirror surfaces onto the second plane of mirror surfaces. In general, the optical system 3707 may be any known imaging system which would enable the optical device 3706 to create a spatial gap in the incoming array of beams 3701 as previously described.

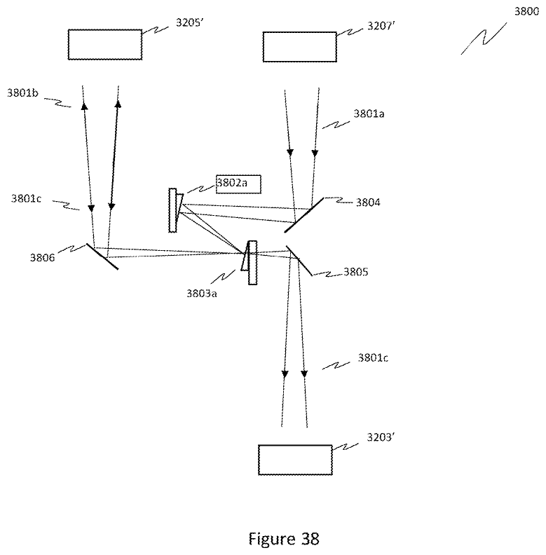

FIG. 38 illustrates a further optical device 3800 of the type configured to alter the configuration of the beams incident on it so as to generate a gap between the those beams. The device includes a mirror array comprising a first array of mirror surfaces 3802 and a second array of mirror surfaces 3803. As previously described, the mirror array comprises pairs of parallel mirror surfaces. The mirror surface 3802a of the first array of mirror surfaces seen in FIG. 38 is parallel to the mirror surface 3803a of the second array of mirror surfaces. The array further includes three flat directing mirrors 3804, 3805, 3806. The device 3800 may be utilised in a WSS such as the M×N WSS 3200 seen in FIG. 32.

The optical device 3800 may be positioned as part of the first optical structure 3208 or the second optical structure 3208′. The optical device 3800 may replace SAM 3204 and/or SAM 3204′, as illustrated in FIG. 33(e).

When the optical device 3800 replaces SAM 3204, the light input 3801a to the optical device 3800 may come from the fan lens 3203. The device 3800 may therefore create a gap in the steering direction between two portions of light 3801b incident on the optical system 3205

In other words, the device 3800 creates a gap in the light's spatial distribution. As previously mentioned, the optical system 3205 may comprise a Fourier lens. The optical system 3205 therefore forms a Fourier conjugate of the incoming light 3205′ in the steering direction such that the light incident on the first programmable deflection plane 3206 has a gap in its angular distribution. The first programmable deflection plane 3206 deflects the incoming light so that the deflected light 3801c passes through the gap created in light 3801b. The deflected light 3801c therefore passes through the mirror array of device 3800 and is reflected by flat mirror 3805. The device 3800 directs the output light to the 4F optical system 3207 (and onward towards the beam steering device 511).

Alternatively, when the optical device replaces SAM 3204′, as shown in FIG. 38, the light input 3801a to the optical device 3800 comes from the 4F optical system 3207′. The device 3800 may therefore create a gap between two portions of light 3801b incident on the optical system 3205′ and the second programmable deflection plane 3206′. The second programmable deflection plane 3206′ directs the incoming light 3801b so that the deflected light 3801c passes through the gap created. The deflected light 3801c therefore passes through the mirror array of device 3800 and is reflected by flat mirror 3805. The device directs the output light to the fan lens 3203′ (and onward towards the output pots 3202). The device may also be used for light travelling in the opposite directions to those shown and described i.e. the device is reversible.

Suitably, the programmable deflection planes described herein are SLM planes. The SLM plane may be a MEMS mirror array. The SLM plane may be an LCOS device. The LCOS device applies a hologram to enable a beam deflection. Alternatively, the SLM plane may be another locally configuration device capable of applying a deflection to a channel from the input.

In the examples described herein the first and second programmable deflection planes are incorporated onto a single SLM device. This utilises fewer components, reduces control complexity and hence cost compared to if the programmable deflection planes are on separate SLM devices. Alternatively, the programmable deflection planes may be on separate SLM devices.

In the examples described herein, optical components are used to route data through the described switches. There is no absorption and re-emission of light, thereby avoiding the lag associated with transmitting data through electronical switches. The optical components also have lower power consumption than equivalent electronical implementations.

The beam steering optical devices described herein comprise prism and/or mirror structures. These enable more efficient use of the SLM panel area thereby allowing significantly improved port count performance for a given SLM resolution. However, the beam steering optical devices could be implemented using other optical elements which achieve the same effect. For example, single or multiple holographic or diffractive optical elements or further active SLM planes may be used to achieve the same optical effect.

The examples described herein incorporate a diffraction grating. However, any demultiplexer which demultiplexes light signals into spatially separated data channels may be used instead of a diffraction grating in any of the examples. Similarly, any multiplexer which multiplexes spatially separated data channels into multiplexed light signals may be used instead of a diffraction grating in any of the examples. Any suitable optical dispersion device may be used as a multiplexer and/or a demultiplexer.

Lenses and other optical components described herein as single structures may be implemented using assemblies having a plurality of components which achieve the same optical effect. Examples of such assemblies are: achromatic doublets, achromatic triplets, Cook doublets, telescopes and microscopes for imaging lenses. The lenses described herein may be implemented using other optics with the same optical power. For example, a curved mirror may be used as a lens. For example, multiple lens elements, mirrors, mirror arrays, catadioptric systems, holographic optical elements or diffractive optical elements may be used as a lens. Separate elements, for example 4F lenses, with the same optical properties can be arranged as separate passes through or from a single physical element.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An optical switch comprising:
a set of input ports, each input port configured to transport an optical signal having at least one component frequency channel;
a set of output ports, each output port configured to transport an optical signal having at least one component frequency channel;
a first programmable deflection plane configured to deflect beams incident on it from the set of input ports to form a deflected array of beams;
a second programmable deflection plane configured to deflect beams incident on it towards the set of output ports; and
a beam steering optical device positioned in the optical path between the first and second programmable deflection planes, the beam steering optical device configured to remap the deflected array of beams from the first programmable deflection plane to form a remapped array of beams directed to the second programmable deflection plane, by changing a spatial positioning and/or orientation of each beam from the deflected array of beams in the remapped array of beams such that the spatial positioning and/or orientation of at least one beam of the deflected array of beams is changed differently to at least one other beam of the deflected array of beams,
whereby the beam steering optical device is configured to split the deflected array of beams into groups of beams, where each group of beams is incident on a different set of optical elements to another group of beams thereby causing each group of beams to follow a different optical path through the beam steering optical device to the other groups of beams so as to cause the geometrical distribution of the groups of beams to change.

2. An optical switch as claimed in claim 1, wherein the beam steering optical device is configured to remap the deflected array of beams by causing them to undergo two individual reflections, refractions or diffractions.

3. An optical switch as claimed in claim 1, wherein the beam steering optical device is configured to remap the deflected array of beams by transposing them in two orthogonal directions.

4. An optical switch as claimed in claim 1, wherein the deflected array of beams has a linear distribution, and the remapped array of beams has a non-linear distribution.

5. An optical switch as claimed in claim 1, wherein the deflected array of beams is a single column array, and the remapped array of beams is a two-dimensional array or the deflected array of beams is a two-dimensional array, and the remapped array of beams is a single column array.

6. (canceled)

7. An optical switch as claimed in claim 1, wherein the deflected array of beams is a two-dimensional array having a first configuration, and the remapped array of beams is a two-dimensional array having a different configuration to the first configuration.

8. An optical switch as claimed in claim 1, wherein the beam steering optical device comprises one or more of the following passive components: a prism, a mirror array, a catadioptric system, a freeform lens and mirror, a diffractive optical element, a diffractive optical element array, a holographic optical element and a holographic optical element array.

9. An optical switch as claimed in claim 1, wherein the beam steering optical device comprises one or more of the following electrically switchable components: an optical microelectromechanical system (MEMS) array, and a liquid crystal on silicon (LCOS) device.

10. An optical switch as claimed in claim 1, wherein the beam steering optical device comprises a first optical element, a second optical element and a conjugate Fourier lens, wherein the conjugate Fourier lens is positioned in the optical path between the first and second optical elements.

11. An optical switch as claimed in claim 1, wherein the beam steering optical device comprises a prism comprising:
a first retroreflecting structure configured to provide an optical path for a first set of beams of the deflected array of beams; and
a second retroreflecting structure configured to provide an optical path for a second set of beams of the deflected array of beams through a periscope prism, so as to alter the conformal arrangement of the first and second sets of beams of the deflected array of beams thereby forming the remapped array of beams having a geometrical distribution which matches the geometrical distribution of the image of the set of output ports on the second programmable deflection plane.

12. An optical switch as claimed in claim 1, wherein the beam steering optical device comprises a mirror array comprising:
a first pair of mirrors configured to provide an optical path for a first set of beams of the deflected array of beams; and
a second pair of mirrors configured to provide an optical path for a second set of beams of the deflected array of beams, the first and second pairs of mirrors having differently angled surfaces so as to alter the conformal arrangement of the first and second sets of beams of the deflected array of beams thereby forming the remapped array of beams having a geometrical distribution which matches the geometrical distribution of the image of the set of output ports on the second programmable deflection plane.

13. An optical switch as claimed in claim 1, wherein the beam steering optical device comprises a prism comprising two orthogonal Amici Roof prisms configured to provide an optical path for the deflected array of beams so as to remap the deflected array of beams from a first configuration in a first direction to form the remapped array of beams having the first configuration in a direction orthogonal to the first direction.

14. (canceled)

15. An optical switch as claimed in claim 1, wherein the beam steering optical device comprises three differently angled reflecting surfaces configured to provide an optical path for the deflected array of beams so as to remap the deflected array of beams from a first configuration in a first direction to form the remapped array of beams having the first configuration in a direction orthogonal to the first direction.

16. (canceled)

17. An optical switch as claimed in claim 1, comprising a single spatial light modulator (SLM) panel comprising both the first programmable deflection plane and the second programmable deflection plane.

18. An optical switch as claimed in claim 17, wherein the images of the beams on the first programmable deflection plane and the images of the remapped array of beams on the second programmable deflection plane cover over 80% of the area of the SLM panel.

19. An optical switch as claimed in claim 1, further comprising an anamorphic correction telescope configured to focus the output of each input port of the set of input ports to an anamorphic focus image at an anamorphic focus point;
wherein the beam steering optical device comprises:
a first structure positioned adjacent to and above the anamorphic focus point, and
a second structure positioned adjacent to and below the anamorphic focus point.

20. An optical switch as claimed in claim 1, further comprising a lens configured to focus the output of each input port of the set of input ports to an input circular focus image at an input circular focus point;
wherein the beam steering optical device comprises:
a first structure positioned adjacent to and above the input circular focus point, and
a second structure positioned adjacent to and below the input circular focus point.

21-29. (canceled)

30. An optical switch as claimed in claim 12, wherein
the first pair of mirrors comprises a first mirror and a second mirror, the first and second mirrors being parallel to one another; and
the second pair of mirrors comprises a third mirror and a fourth mirror, the third and fourth mirrors being parallel to one another.

31. An optical switch as claimed in claim 30, wherein
the first set of beams of the deflected array of beams is incident on the first mirror in a first direction and leaves the second mirror in the first direction; and
the second set of beams of the deflected array of beams is incident on the third mirror in a second direction and leaves the fourth mirror in the second direction.

32. (canceled)

33. An optical switch as claimed in claim 1, wherein the optical switch comprises a split aperture mirror positioned in the optical path between the set of input ports and the first programmable deflection plane and between the first programmable deflection plane and the beam steering optical device and/or wherein the optical switch comprises a split aperture mirror positioned in the optical path between the beam steering optical device and the second programmable deflection plane and between the second programmable deflection plane and the set of output ports.

34. (canceled)

35. (canceled)
